(19) United States
(12) Patent Application Publication
(10) Pub. No.: US 2004/0073444 A1
(43) Pub. Date: Apr. 15, 2004

(54) Method and apparatus for a financial database structure

(76) Inventors: Li Li Peh, Singapore (SG); Devika Maria Dutt, Singapore (SG); Teck Hock Png, Singapore (SG); Ka Theng Poh, Singapore (SG); Stephan Stadelmann, Singapore (SG)

Correspondence Address: Lawrence N Ginserg, 21 San Antonio, Newport Beach, CA, 92660-9112, US

(21) Appl. No.: 10/466,266

(22) PCT Filed: Nov. 16, 2001
(86) PCT No.: PCT/SG01/00234

(30) Foreign Application Priority Data
Jan. 16, 2001 (SG) 200100230-2

(51) Int. Cl. G06F 17/60

(52) U.S. Cl. 705/1; 705/35; 707/104.1

(57) ABSTRACT

A financial database structure (200) comprises an organization portion (205), a financial portion (210) and a non-financial portion (215). Entity records (220, 230 and 240) have a variety of sub-entity records (221-226, 231-235, and 241-244) coupled thereto, and the entity records (220, 230 and 240) and their sub-entity records (221-226, 231-235, and 241-244) are inter-coupled.

### FIELD OF THE INVENTION

The present invention relates to a financial database structure and more particularly a financial database structure which can support a variety of database applications.

### BACKGROUND OF THE INVENTION

A database system comprises a database structure and a database application. Database structures are often referred to as database models which provide a logical map of organized storage of data items. A database structure may be considered a blue print that shows various data tables or records, a variety of data items in the records, and the links between the records. A database application uses a database structure as a resource, and the database application can relate, compare and analyze the data records.

Separate processes are used to feed or populate the records in the data structure. These processes may be automatic with no human intervention, semi-automatic with some human intervention, or totally manual. In addition, translators may be employed to ensure that information coming from different sources are processed and formatted in accordance with the specifications of the database structure. Such translation can include translations of languages and character sets, as well

Typically, when an organization requires information to be maintained for a specific application, for example, asset management, user and potential user requirements of a database application are identified and specifications of a database system prepared. A database system that meets the specifications is then either purchased or a customized system designed.

In either case, the database structure of the database system is typically static, and specifically created for the database application, i.e. in this example specifically for asset management. This approach has resulted in a new database structure being created or set up, whenever the need for a new database application arose. As a result, most organizations have a variety of disparate database systems having a corresponding variety of database structures, which often do not, or cannot, share information seamlessly, and do not facilitate integration between the database systems. Examples in an organization that provides financial information would be Times Series, Company Reports, Fund Portfolio's, Company Relations and Ownership's, and Corporate Actions

A simple example would be a typical midsize retail organization. Such an organization typically has separate database systems with specific corresponding database applications for stock management, accounting, order processing, human resource, security, etc. Typically, each of these systems would have a specific financial database structure. There is little, if any, integration between the database systems.

While such an adhoc approach to setting up database systems is attractive due to the relative ease of implementation of such standalone applications, and the wide variety of off-the-shelf products, there are several disadvantages to this approach.

A primary disadvantage is the difficulty or inability to share information across the various database systems, as each system has its own unique database structure. Another disadvantage is the significant duplication of resources, and hence the cost associated with that, to support multiple database systems. Yet another disadvantage is the significant amount of work that is duplicated when inputting the same information to several database systems. A further disadvantage is the limited amount of synergistic value that can be drawn from such disparate database. Other disadvantages include, deterioration of data quality, and the additional technical maintenance and support resources that are required.

### BRIEF SUMMARY OF THE INVENTION

The present invention seeks to provide a method and apparatus for a financial database structure which overcomes, or at least reduces the above mentioned problems of the prior art.

Accordingly, in one aspect, the present invention provides a database comprising:

an organization entity section for storing at least one organization entity record of at least one organization entity, and for storing a plurality of organization sub-entity records, wherein at least one of the plurality of organization sub-entity records is directly coupled to the at least one organization entity record;

a financial entity section coupled to the organization entity section, the financial entity section for storing at least one financial entity record of at least one financial entity, and for storing a plurality of financial sub-entity records, wherein at least one of the plurality of financial sub-entity records is directly coupled to the at least one financial entity record; and

a non-financial entity section coupled to the organization entity section and the financial entity section, the non-financial entity section for storing at least one non-financial entity record of at least one non-financial entity, and for storing a plurality of non-financial sub-entity records, wherein at least one of the plurality of non-financial sub-entity records is directly coupled to the at least one non-financial entity record.

In another aspect, the present invention provides a financial database comprising:

an organization entity section for storing at least one organization entity record of at least one organization entity;

a financial entity section coupled to the organization entity section, the financial entity section for storing at least one financial entity record related to the at least one financial entity; and

a non-financial entity section coupled to the organization entity section and the financial entity section, the non-financial entity section for storing at least one non-financial entity record related to at least one of, the at least one non-financial entity and the at least one organization entity.

In yet another aspect, the present invention provides a method comprising the steps of:

a) defining at least one organization entity record for at least one organizational entity;

b) defining at least one financial entity record for at least one financial entity;

c) defining at least one non-financial entity record for at least one non-financial entity;

d) defining a plurality of sub-entity records for each of the at least one organization entity record, the at least one financial entity record, and the at least one non-financial entity record;

e) determining a plurality of relationships between at least some of the plurality of sub-entity records and the at least one organization entity record, the at least one financial entity record, and the at least one non-financial entity record; and

f) inter-coupling the at least some of the plurality of sub-entity records, the at least one organization entity, the at least one financial entity and the at least one non-financial entity in accordance with the plurality of relationships determined instep (e).

### BRIEF DESCRIPTION OF THE DRAWINGS

An embodiment of the present invention will now be more fully described, by way of example, with reference to the drawings of which:

FIG. 1 shows a data structure in accordance with the present invention;

FIG. 2 shows a data structure in accordance with the present invention;

FIG. 3A-3AG show a data structure in accordance with the present invention; and

FIG. 4 shows a flow chart detailing a process for creating the database structure in FIGS. 2 and 3.

### DETAIL DESCRIPTION OF THE DRAWINGS

The present invention, as will be described below, is a generic financial database structure which defines records of organizational entities, financial entities, and non-financial entities, and includes coupling between the records of these entities. New entity records can be added and coupled to the existing entity records, and any of a variety of sub-entity records coupled to the entity records.

The terminology that will be used in the following description is known to those skilled in the art. The term “entity” or entities is an event(s) or thing(s) about which information is to be saved in a database system. “Attribute” or “attributes” describe properties of an entity, and a “relationship” describes how entities and attributes that are coupled are related to each other.

Besides terminology, standards have been adopted for various data items that are to be stored in the financial database. To the extent possible, internationally recognized standards are used, and some are shown in TABLE. 1. It will be appreciated that abbreviations used therein will be known to those skilled in the art, and no additional details are provided herein.

TABLE 1

| Standard | Organization |
|---|---|
| Country Code | ISO 3166, etc. |
| Currency Code | ISO 4217, etc. |
| Language Code | ISO 639 |
| Industry Classification | MSCI, IPTC, Hong Kong, |
| | Singapore, Japan, Thailand, |
| | Taiwan, etc. |
| Instrument Classification | CFI |
| Rating Schemes | Moody's, S&P, JCR, etc. |
| Identification Symbols, | ISIN, Common Code, National |
| | Identifier, Exchange Ticker, |
| | Reuters Identification Codes |
| | (RIC), SWIFT, BIC, FDS, etc. |
| Trading Conventions, | Exchange specific |
| Settlement Conventions, | Exchange specific |
| Holiday Conventions, | Country, City, Exchange specific |
| etc. | |

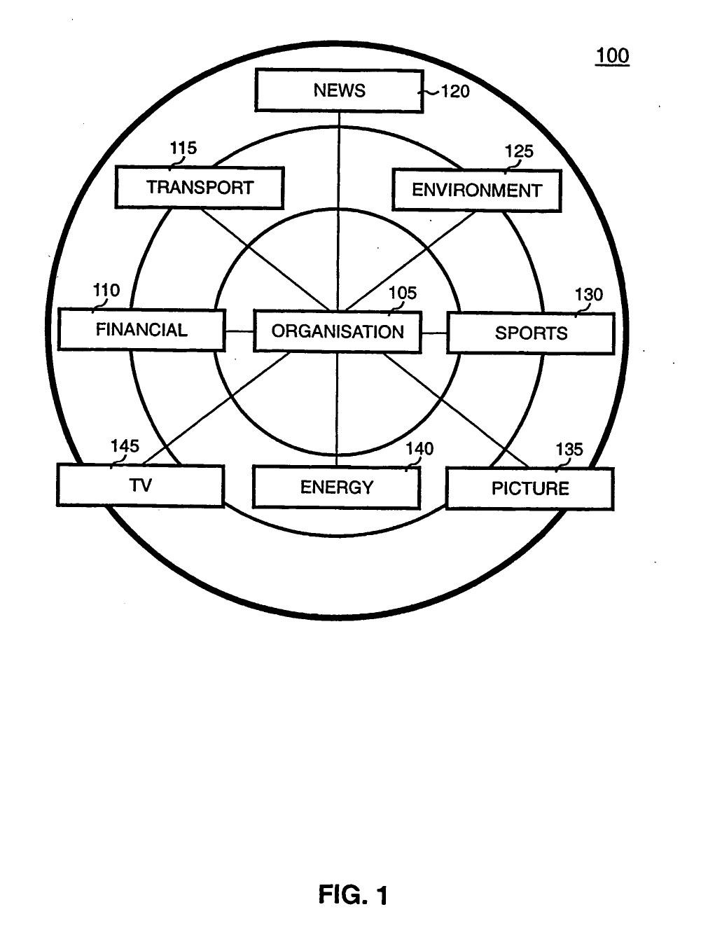

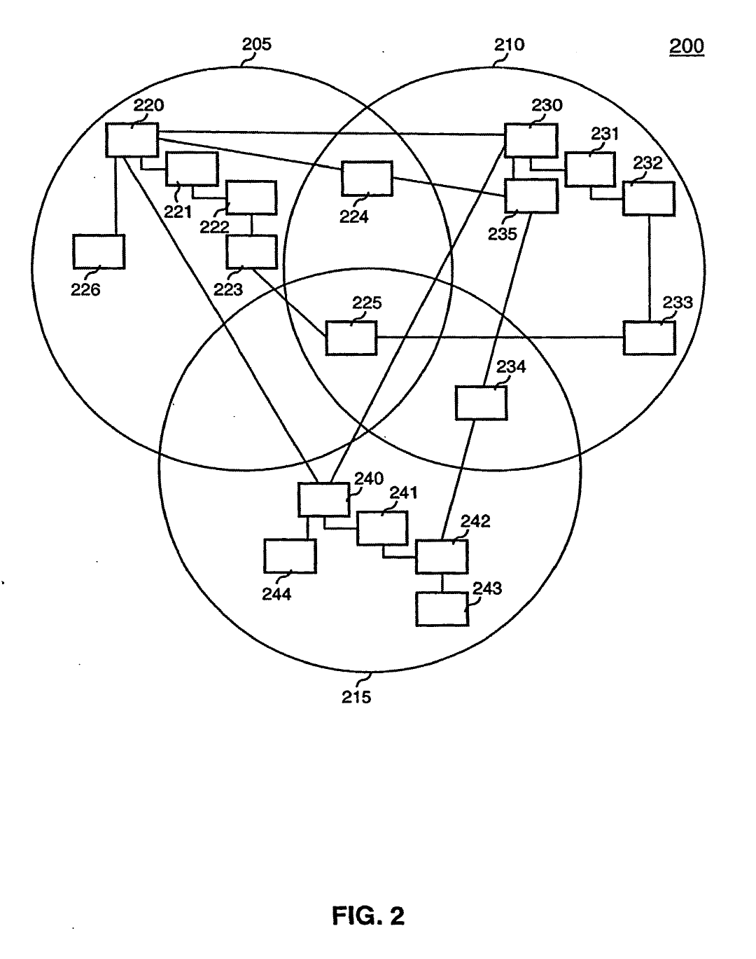

In FIG. 1, a financial database structure 100 comprises a variety of entity records including, an organization entity record 105, financial entity record 110, transport entity record 115, news entity record 120, environment entity record 125, sports entity record 130, picture entity record 135, energy entity record 140, and television entity record 145. All the entity records 105-154 can have attributes that describe the properties of the respective entity.

The organization entity record 105 can represent a country, a company, a national or multi-national government body, a public or private institution, a financial exchange, an association, a political party, a sports club, an individual, an event, etc. The entities will be related to one another as well as to a variety of sub-entities, and there can also be relationships between sub-entities.

The entity records of primary concern in the financial database structure 100 are the organization entity record 105 and the financial entity record 110. The other entities i.e. the transport entity record 115, news entity record 120, environment entity record 125, sports entity record 130, picture entity record 135, energy entity record 140, and television entity record 145, store non-financial information which is related to the organization entity record 105 and the financial entity record 110.

The database structure 100 can be created on a variety of computer database platforms including Oracle™ by Oracle Corporation of the USA, and can be applied in a computer networked environment, as is known in the art. Other database platforms and systems produced by IBM Corporation, Informix Corporation, Sybase Inc., and Microsoft Corporation, all of the U.S.A, can also be used.

The database structure 100 advantageously includes relationships between the organization entity record 105, the financial entity record 110 and the non-financial entity records, thus providing database applications with access to non-financial information and the effect such information has on an organization and its financial position. This, in turn, results in value added services to users of a financial database system. The database structure 100 provides a holistic view and understanding of organisations, financial and non-financial markets by itself and in relationship to each other, with a minimum of maintenance and support staff requirements. It builds the fundamentals for tracking and profound analysis of performance, impact and behaviors of the above mentioned entities in financial, non-financial and governmental environment, as it brings all these together.

With reference to FIG. 2, a financial database 200 includes an organization entity section 205, a financial entity section 210 and a non-financial entity section 215. The organization entity section 205 comprises an organization entity record 220 of at least one organization entity that has a defined identity. It could, for example be a person, group of persons, a private or public company, or a financial exchange. The organization entity record stores information of a company or person as attributes. The attributes include the name of the company or person, when formed or born, as appropriate, the business activity, equity profile and more.

The organization entity section 205 also includes a variety of sub-entities records 221-226 that are coupled either directly or indirectly to the organization entity record 220. The sub-entity records 221-226 store information relating to the organization entity record 220 including industrial activity, organization relationship with other organization entities indicating whether it's a holding, and if so the type of holding, the value of the holding and such related information. The sub-entity records also store information on reports, ratings, meetings, financial instruments, business hours, trading places of financial instruments, and more.

The financial entity section 210 comprises a financial entity record 230 of at least one financial entity. The financial entity record 230 relates to any asset of the organization entity represented by the organization entity record 220, that has a value, or based on which a value may be derived. For example, stock, bonds, commodities, fund unit, warrants, indices, etc. Where a financial entity is a financial instrument, the financial entity record include attributes such as name if the instrument, its status, nominal amount, index, etc.

The financial entity section 210 also comprises a variety of sub-entities records 231-235 that are coupled directly or indirectly to the financial entity record 230. The sub-entity records 231-235 store information relating to the financial entity record 230 and, where the financial entity is a financial instrument, the sub-entity records 231-235 include ratings, earnings per share, instrument capital, terms and conditions, and the like.

The non-financial section 215 comprises at least one non-financial entity record 240. The non-financial entity record 240 relates to any entity which directly or indirectly affects performance of the organization entity represented by the organization entity record 220, and which has a predetermined relationship with that organization entity. In addition, the non-financial entity record 240 relates to any entity which directly or indirectly affects performance of the financial entity represented by the financial entity record 230, and which has a predetermined relationship with that financial entity. Examples of non-financial assets are real estates, property, vessels, and manufactured goods, such as metal bars, semiconductor chips, and agricultural produce.

The non-financial section 215 also includes a plurality of sub-entity records 241-244 that are directly or indirectly coupled to the non-financial entity record 240. The sub-entity records store a variety of information relating to the financial entity record 240, including weather, games results such as football scores, news reports and the like.

Couplings between the entity records 220, 230 and 240, and couplings between sub-entity records 221-226, 231-235, and 241-244 indicate relationships between the records. These relationships are defined and setup as an integral part of the data structure, thus, advantageously allowing a database application to not only access information about an organization and its financial assets, but also to related non-financial information. This will allow a database use to relate, compare and analyze an organization better than conventional database systems that do not include non-financial information.

For example, a football club, which is an organization entity, floats its shares, which constitutes a financial entity, on a stock exchange, which is an organization entity. The performance of the stock would be directly related to the number of victories of the football club in a championship of a particular category. Then, based on an assumption that more spectators/supporters will attend the games of the football club, there will be a greater number of tickets sold and higher sales of franchised goods related to the football club. In addition, such information can be useful for commentators in the field of sports media.

Another example is the Southern Oscillator Index (SOI) which provides information about changes in water temperature in the Straits of Darwin. On the assumption that the SOI is a relative indicator of the El Nino/La Nina effect which influences the climate in the Asia Pacific region, the SOI can be used to provide a forecast on agricultural production and thus, has a direct impact on the commodities market around the world.

As a further example, consider the marathon discipline in the Olympic games with a hundred participants. We know that the International Olympic Council (IOC) is the governing body of the Olympics, and is therefore the super entity over all past, present and future Olympic games. Olympics 2000 is an organizational entity, the marathon event is a sub-entity, and the runners in the marathon are object entities. The IOC might finance the Olympic 2000 games by is issuing debentures, which is financial entity. Thus, the information can be stored in the database structure in accordance with the present invention, as described.

Other examples of organization entities are European Community, with the member countries being sub-entities; US Elections, North American Free Trade Agreement (NAFTA), Y2K, etc.

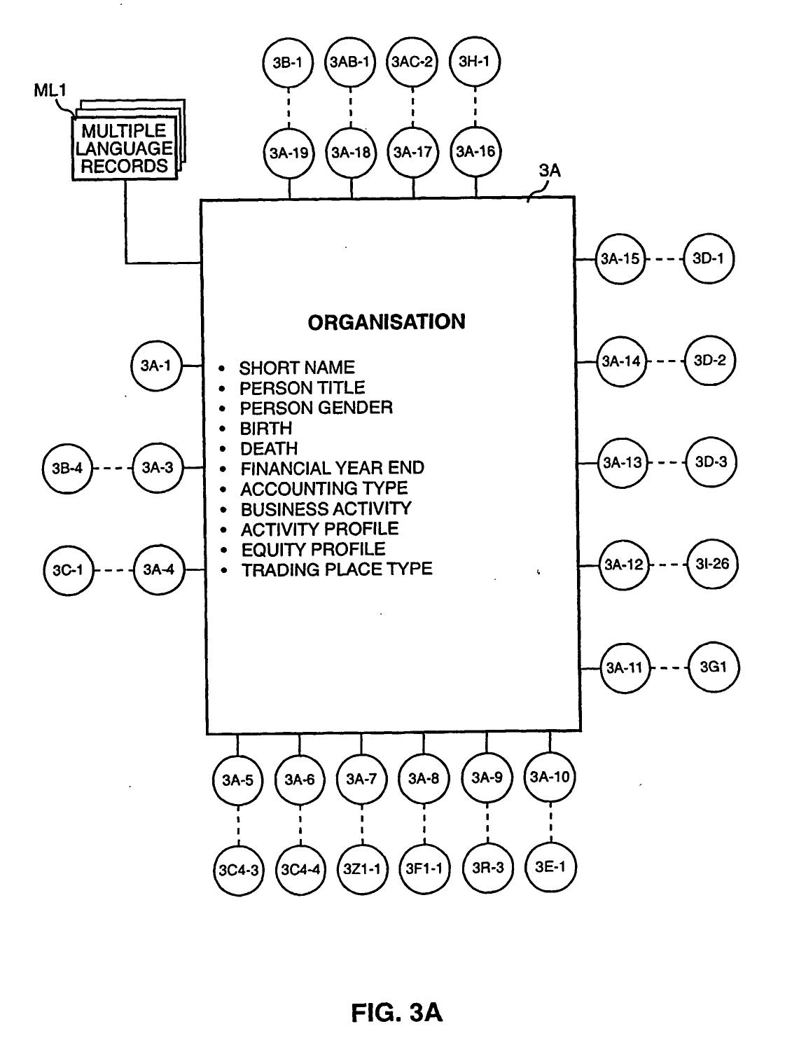

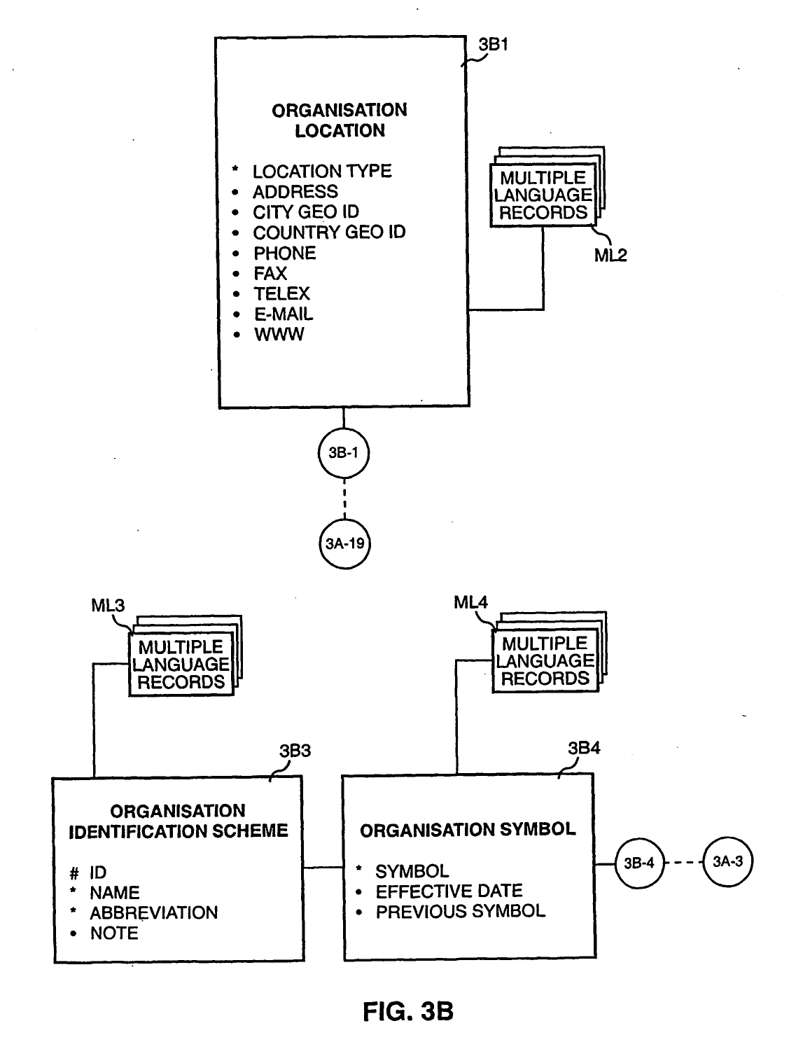

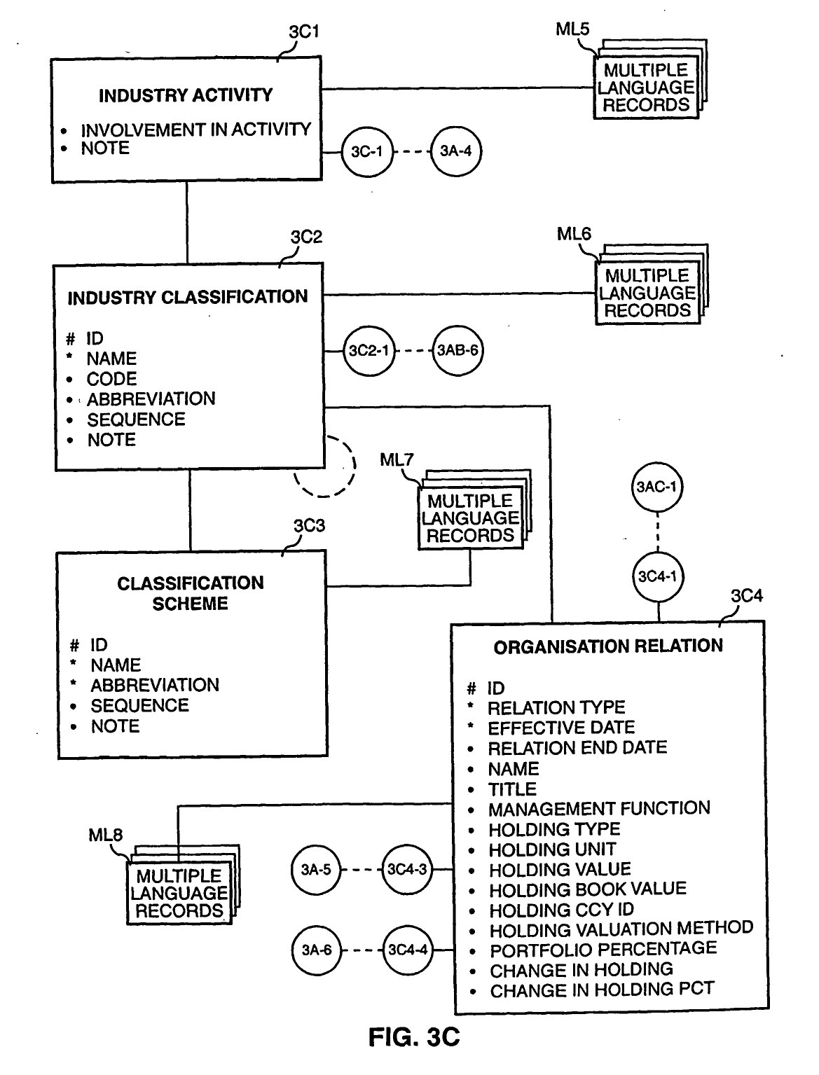

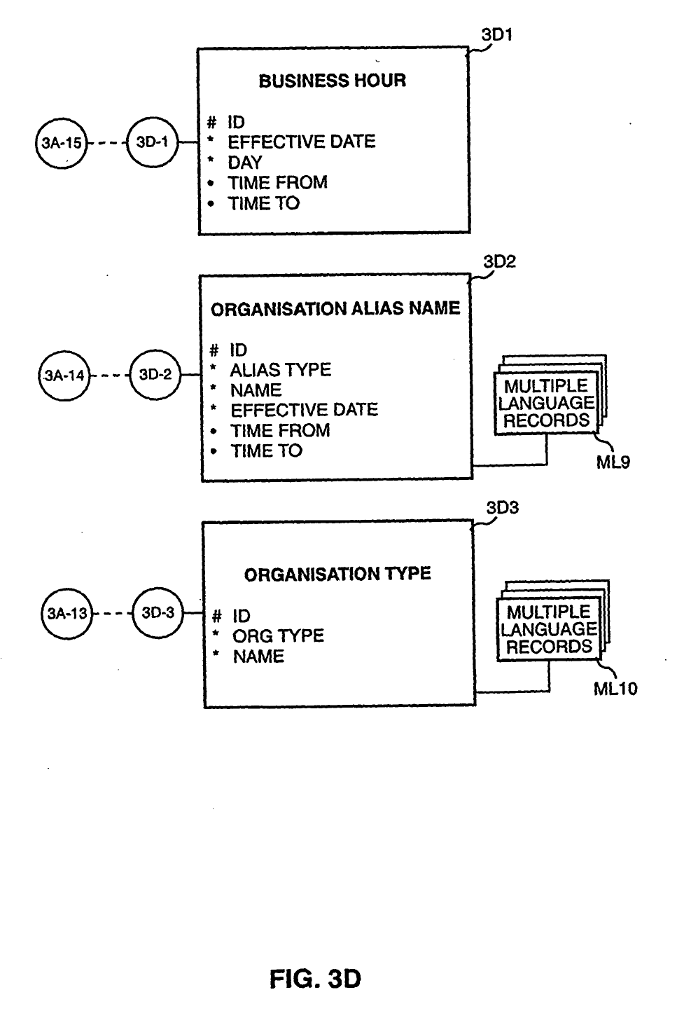

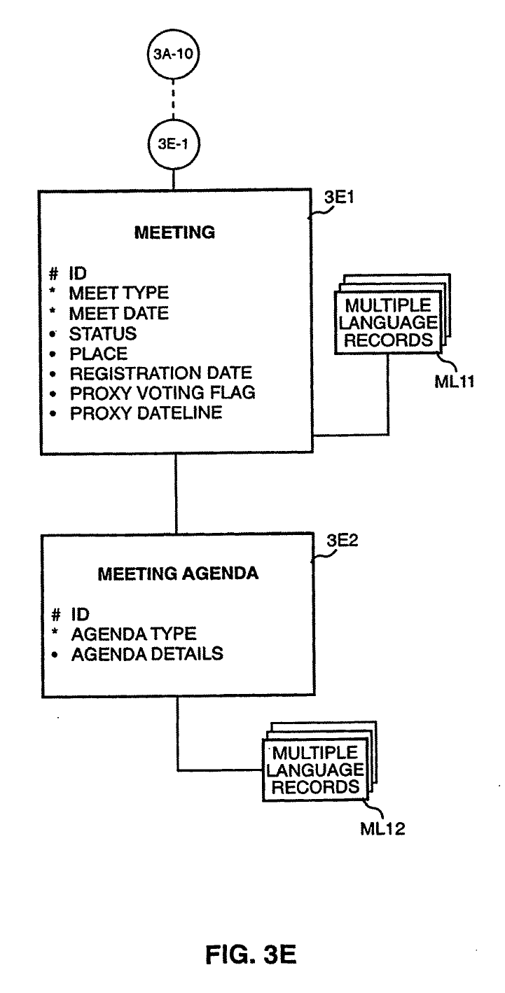

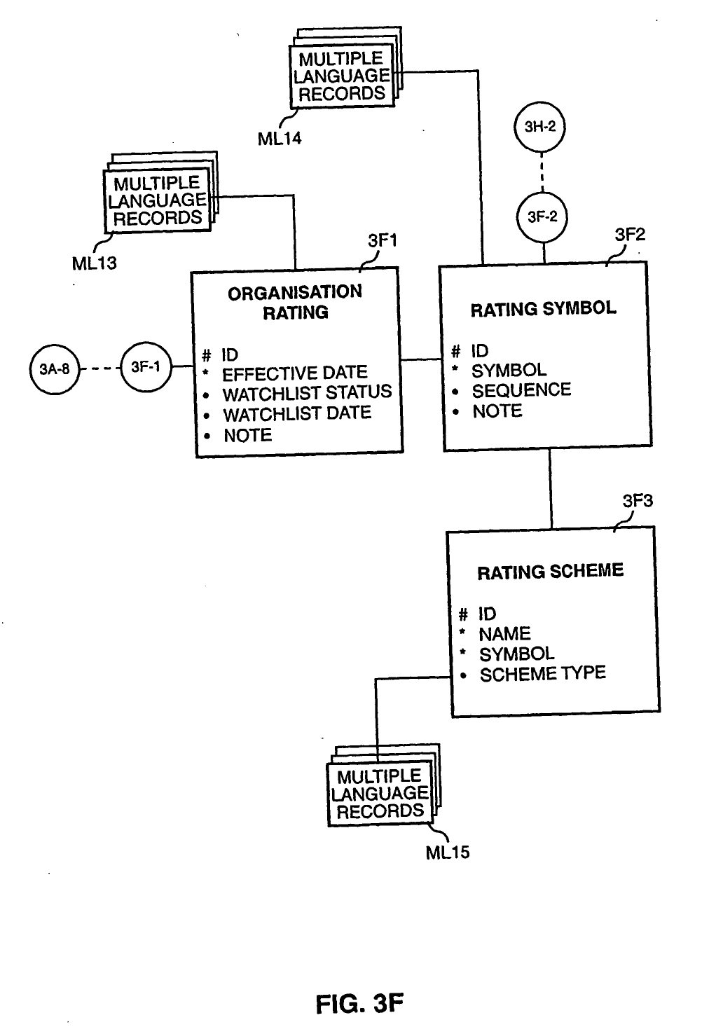

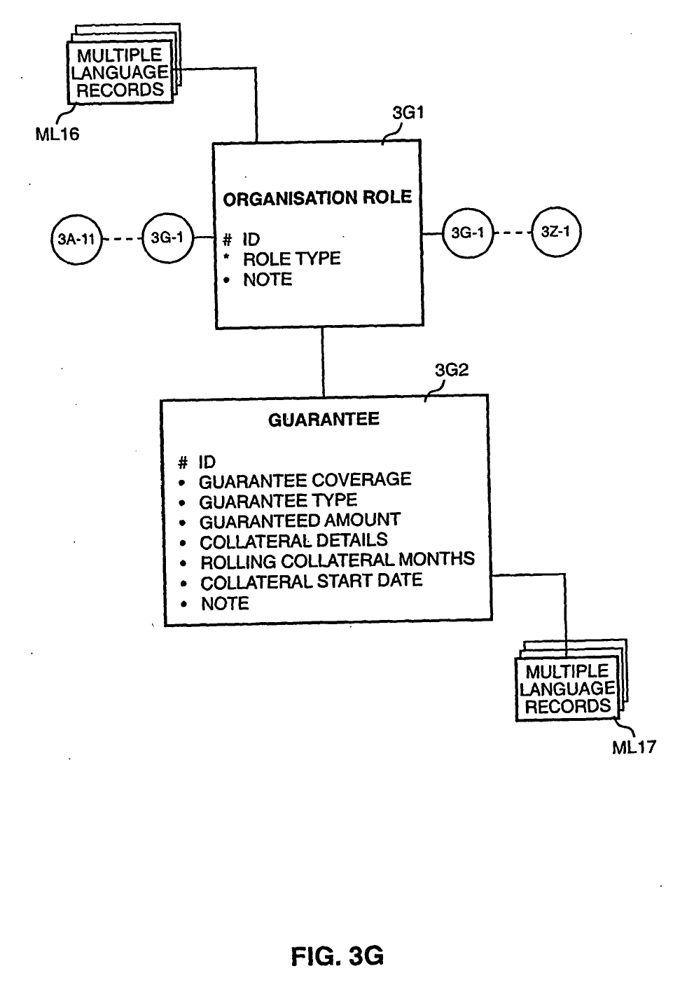

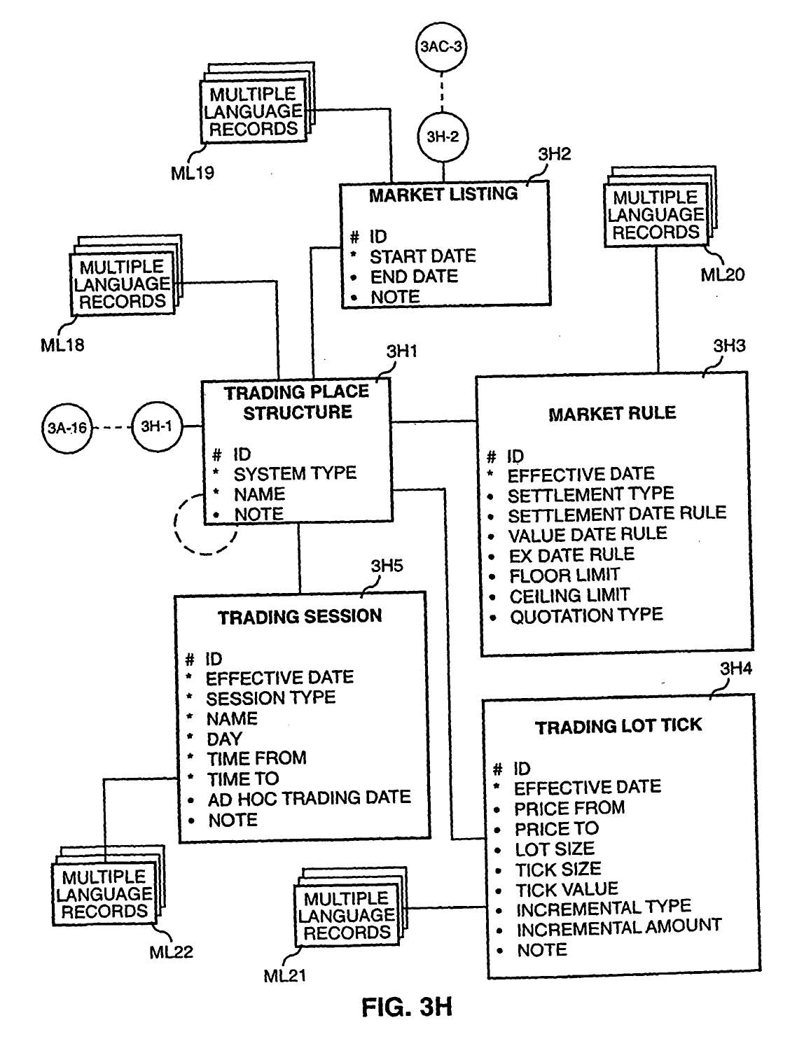

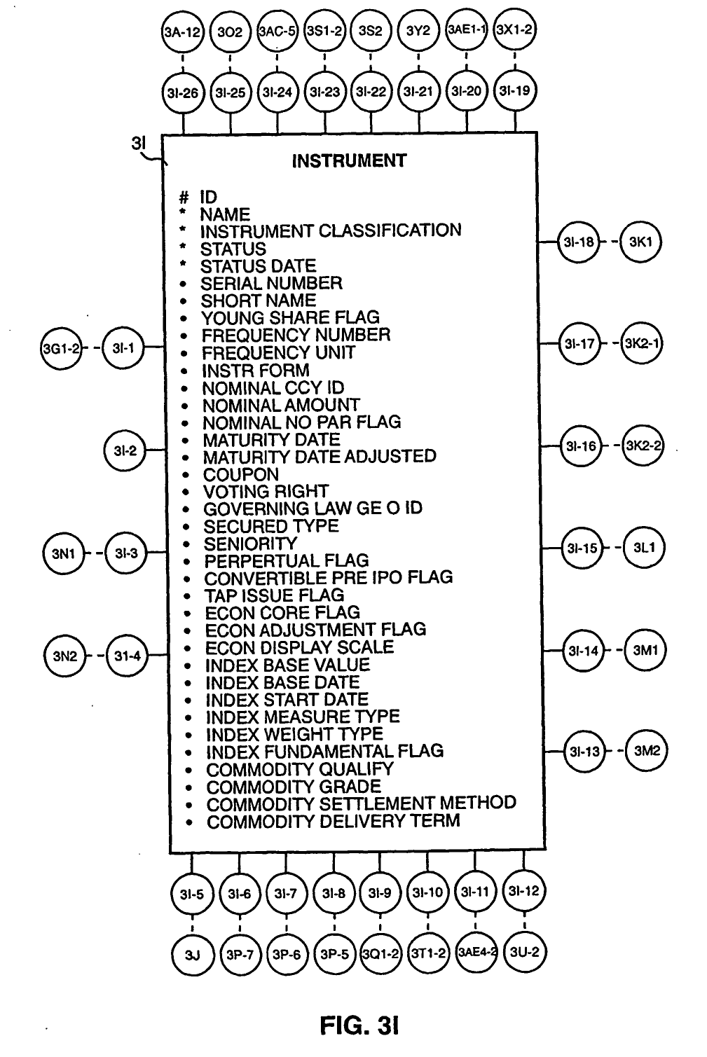

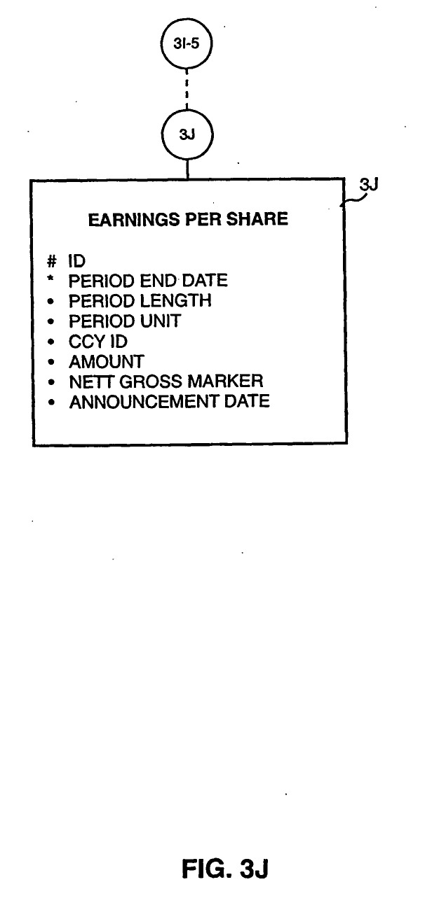

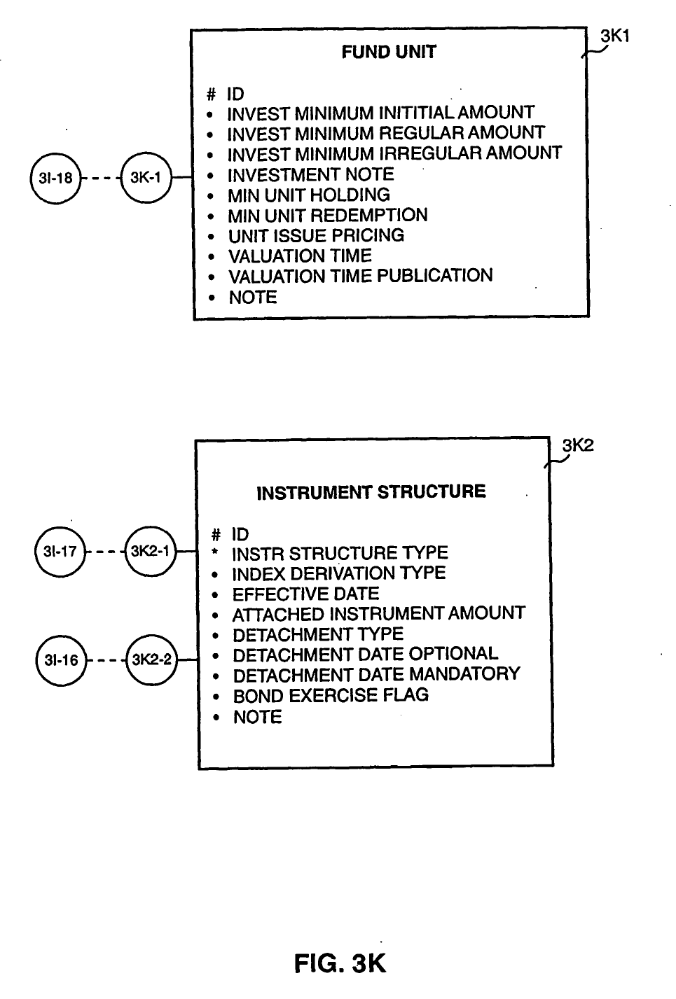

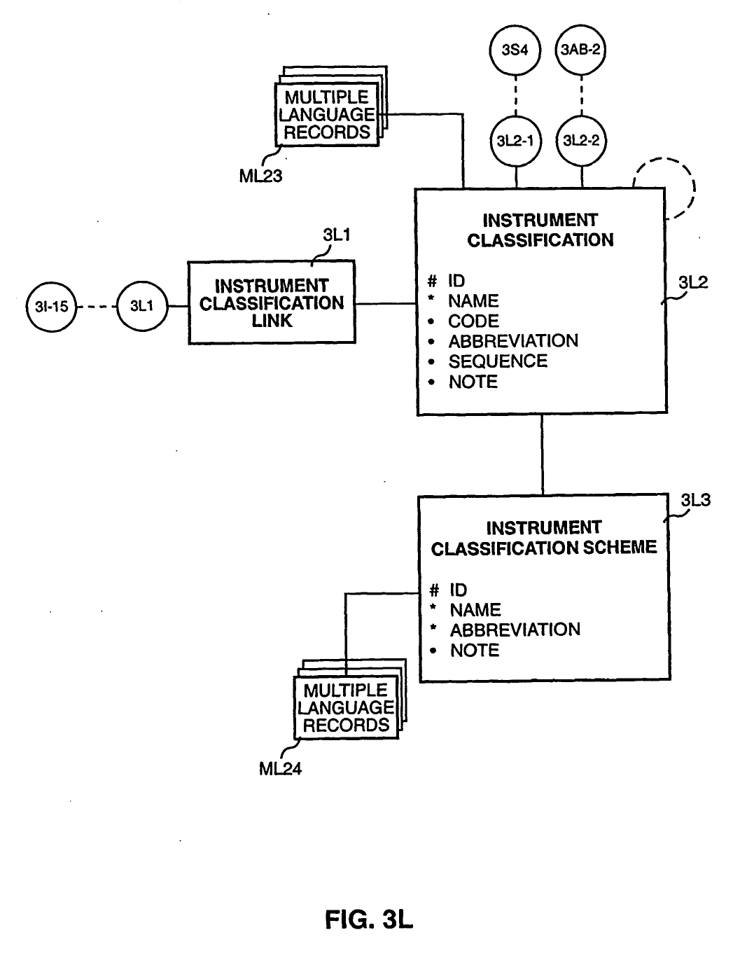

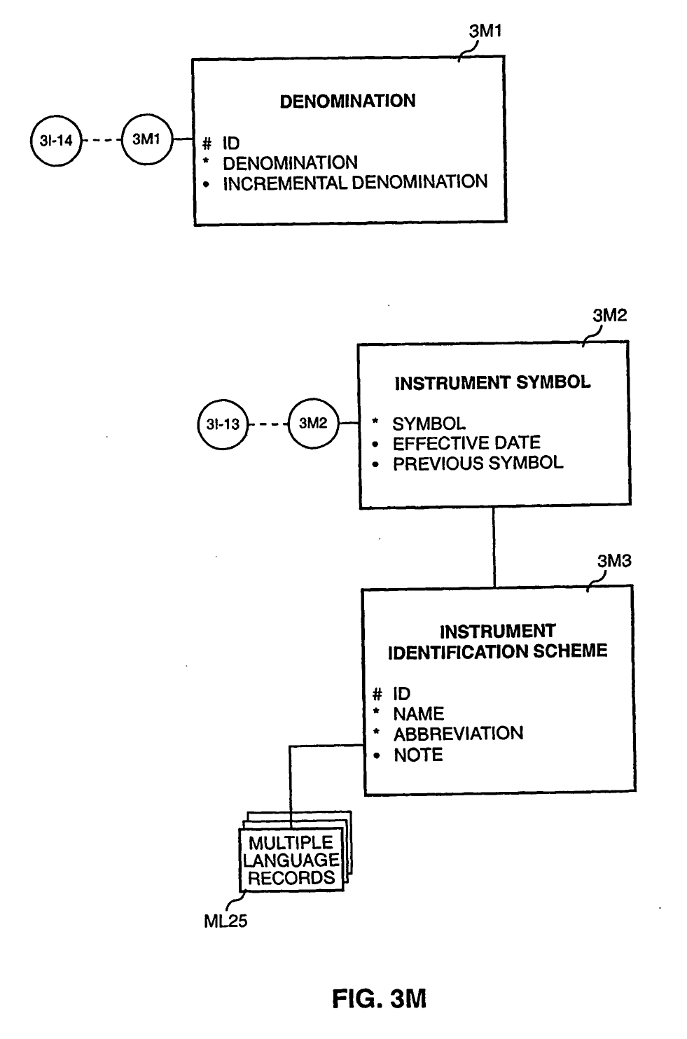

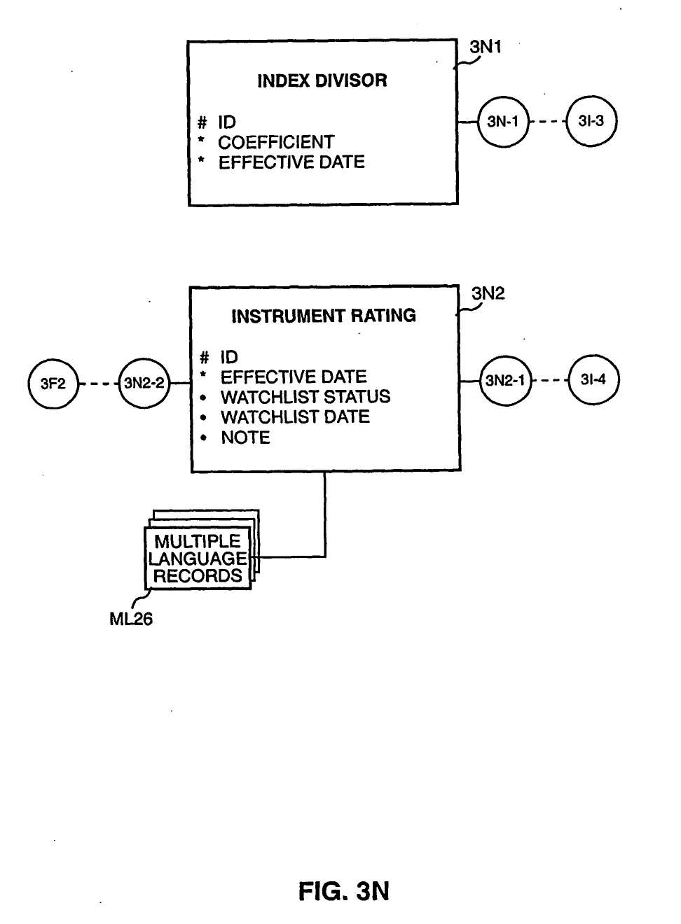

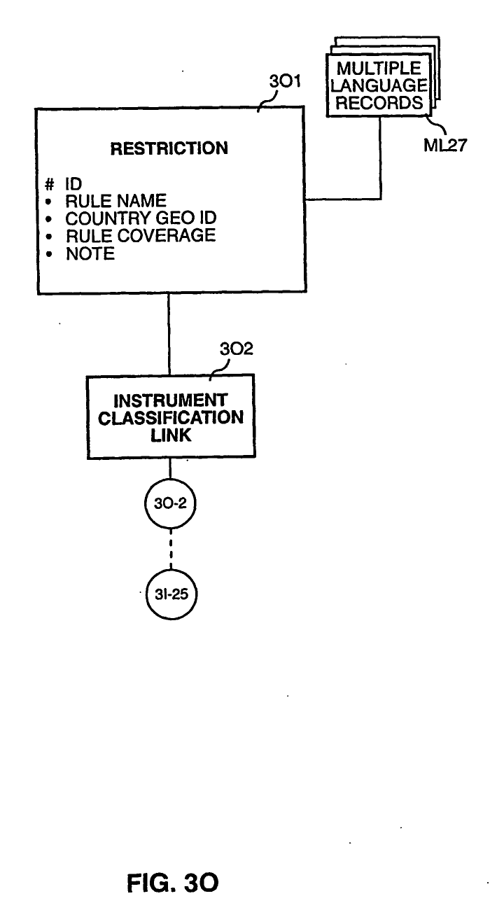

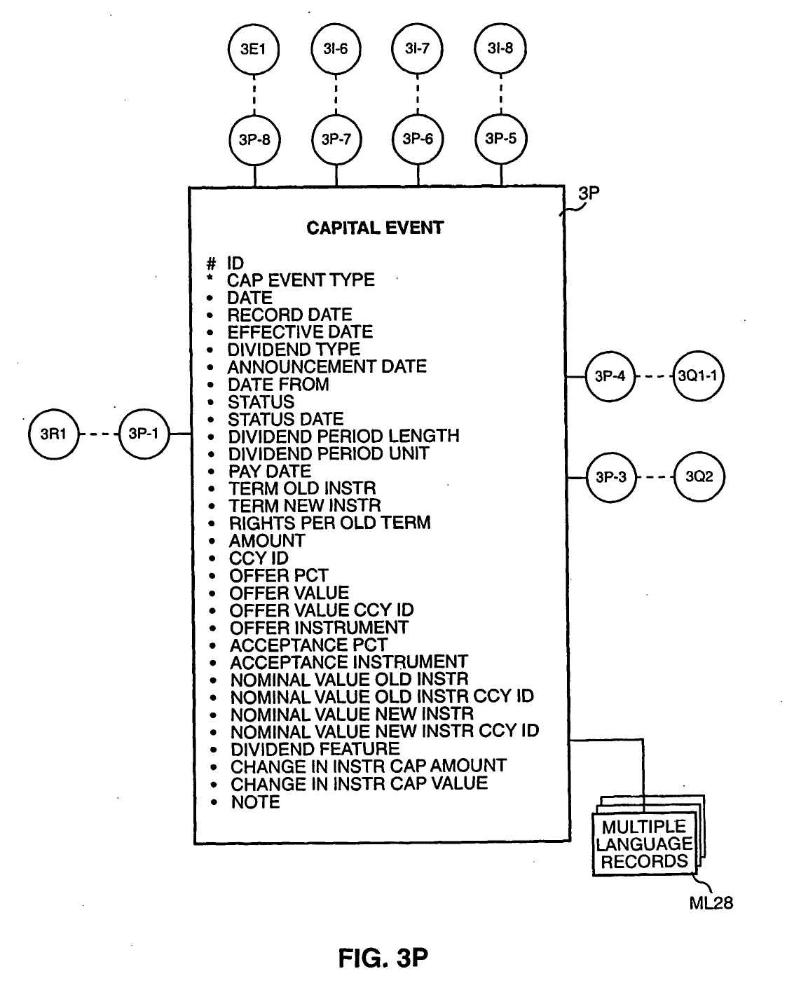

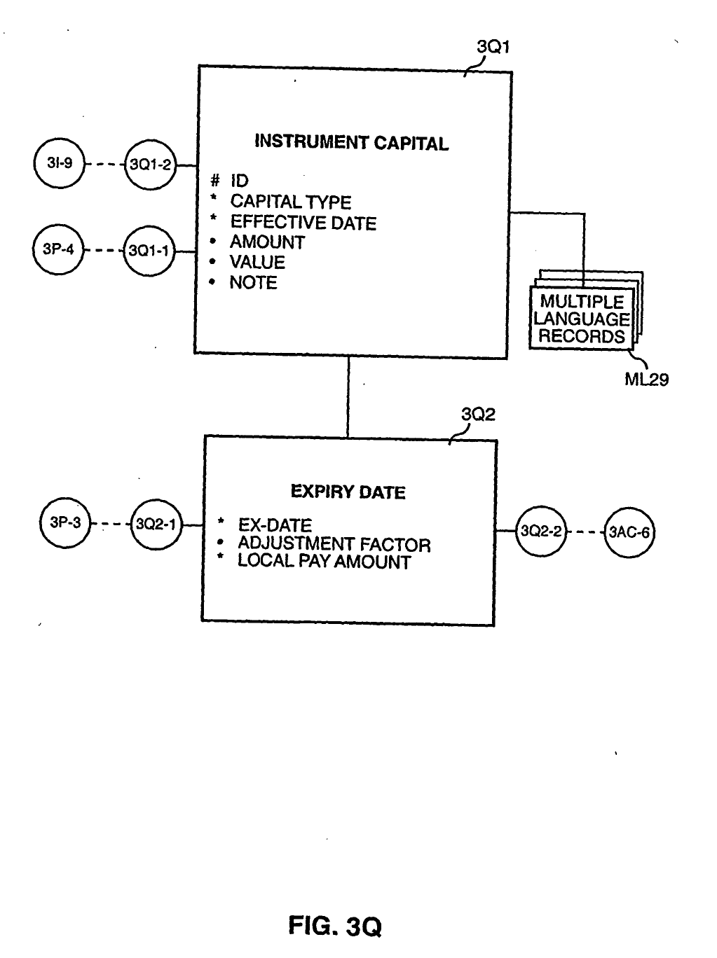

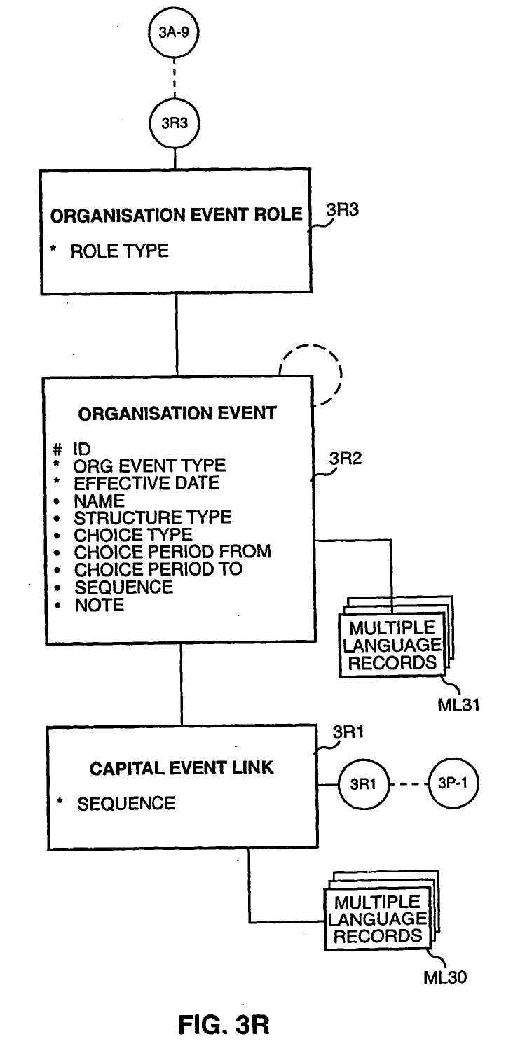

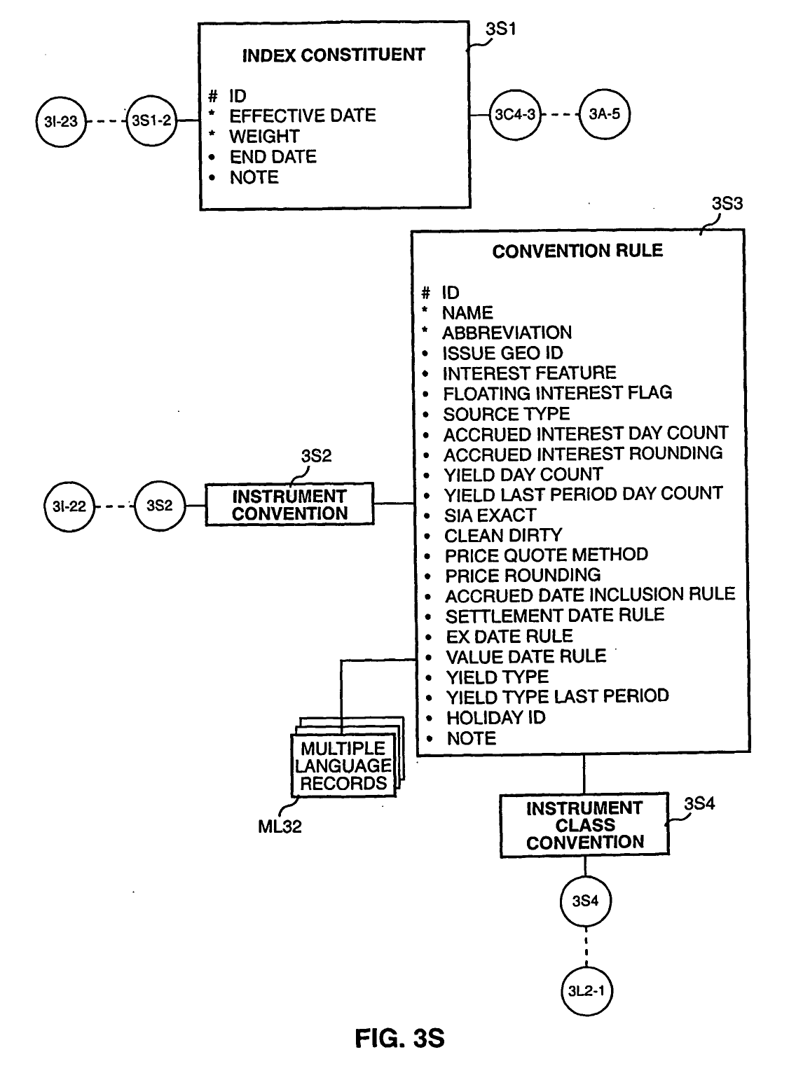

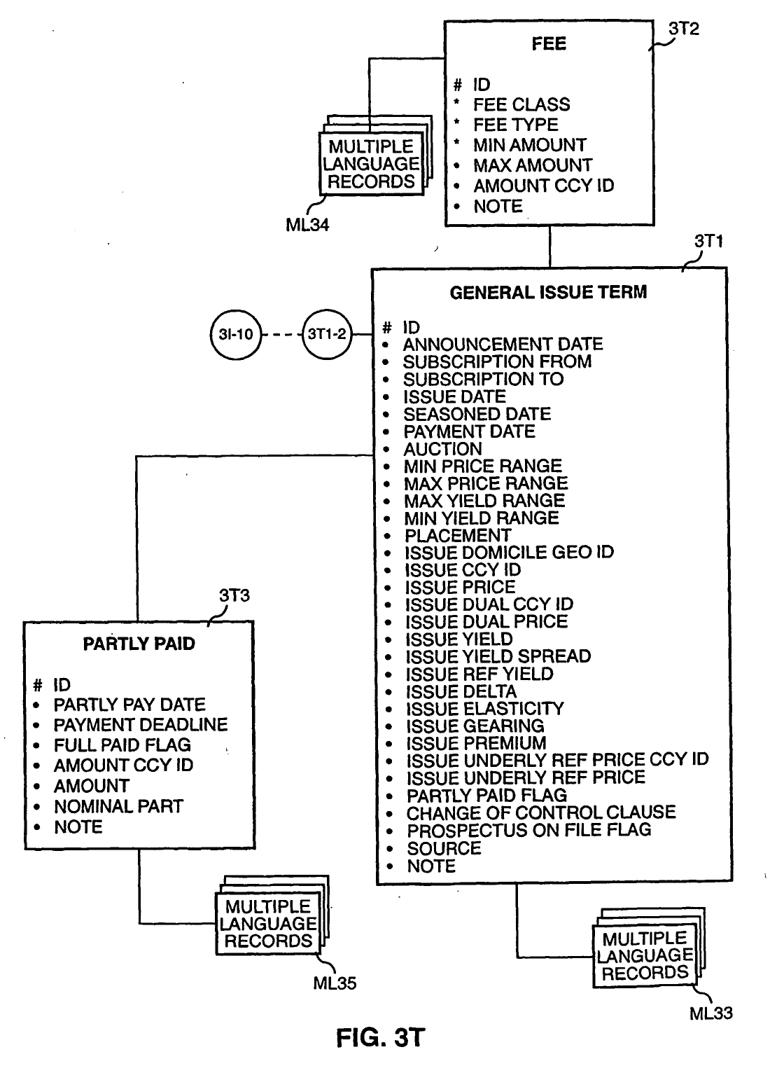

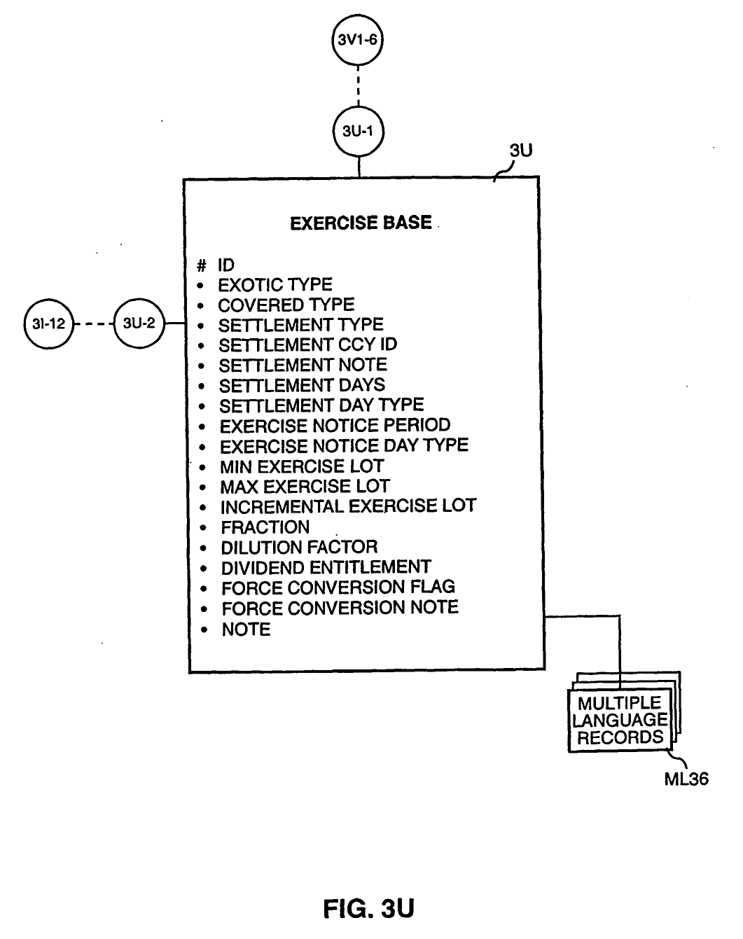

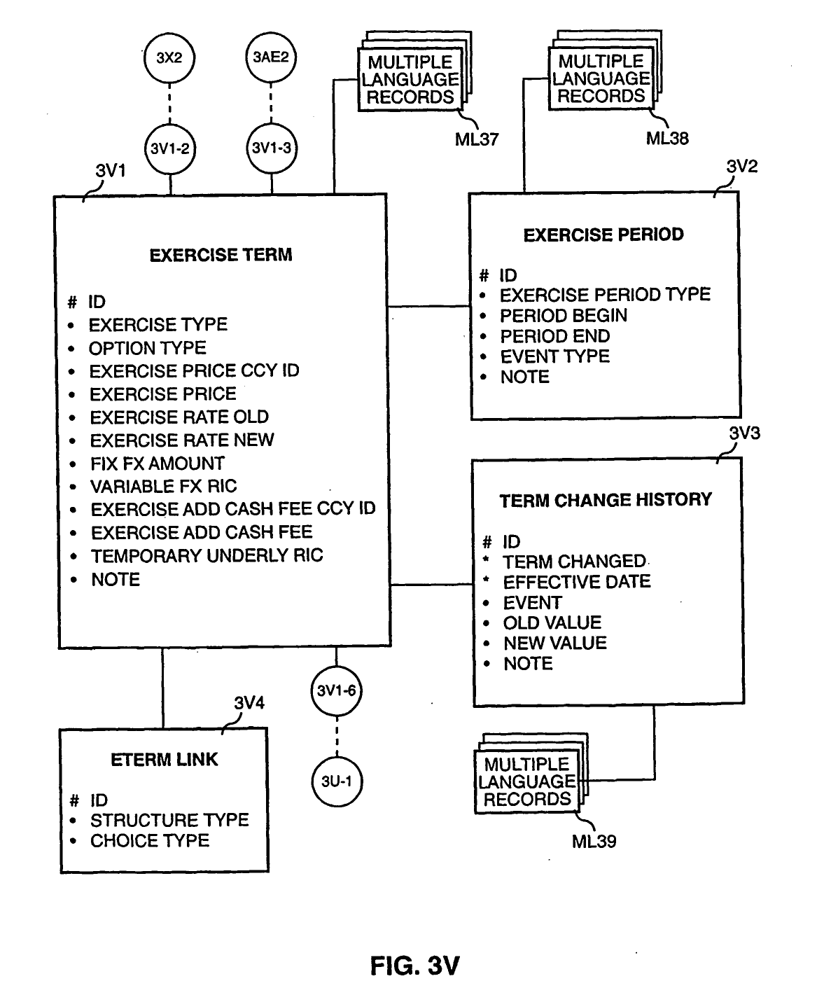

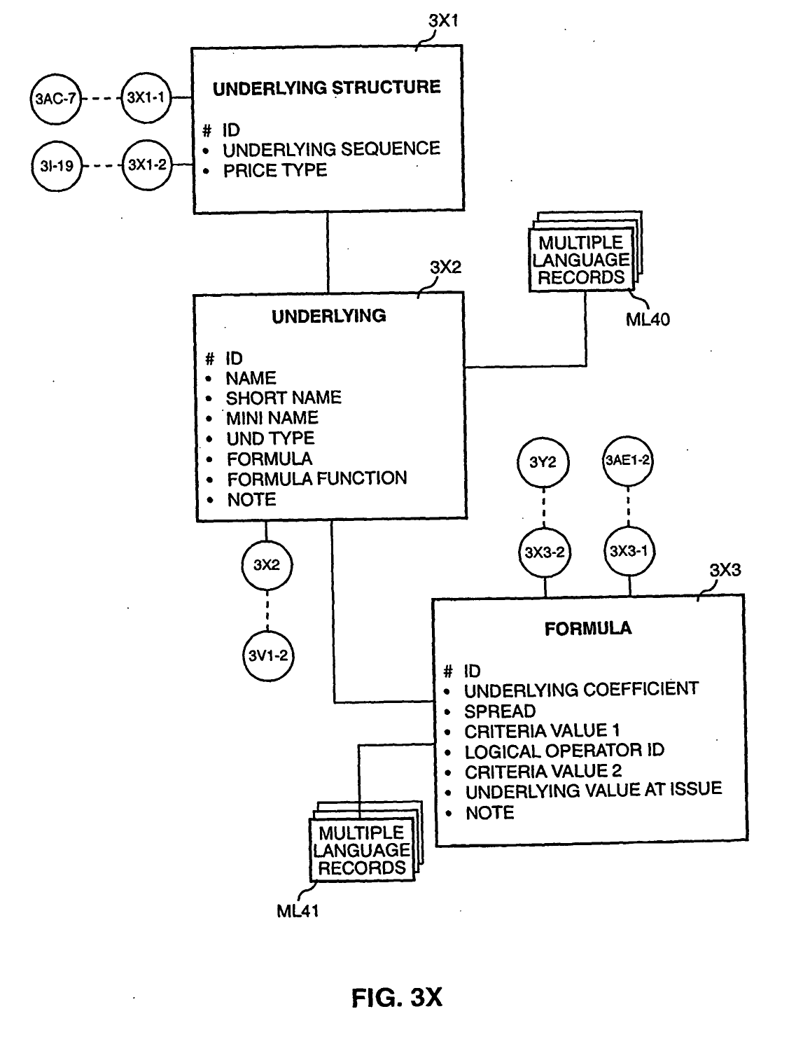

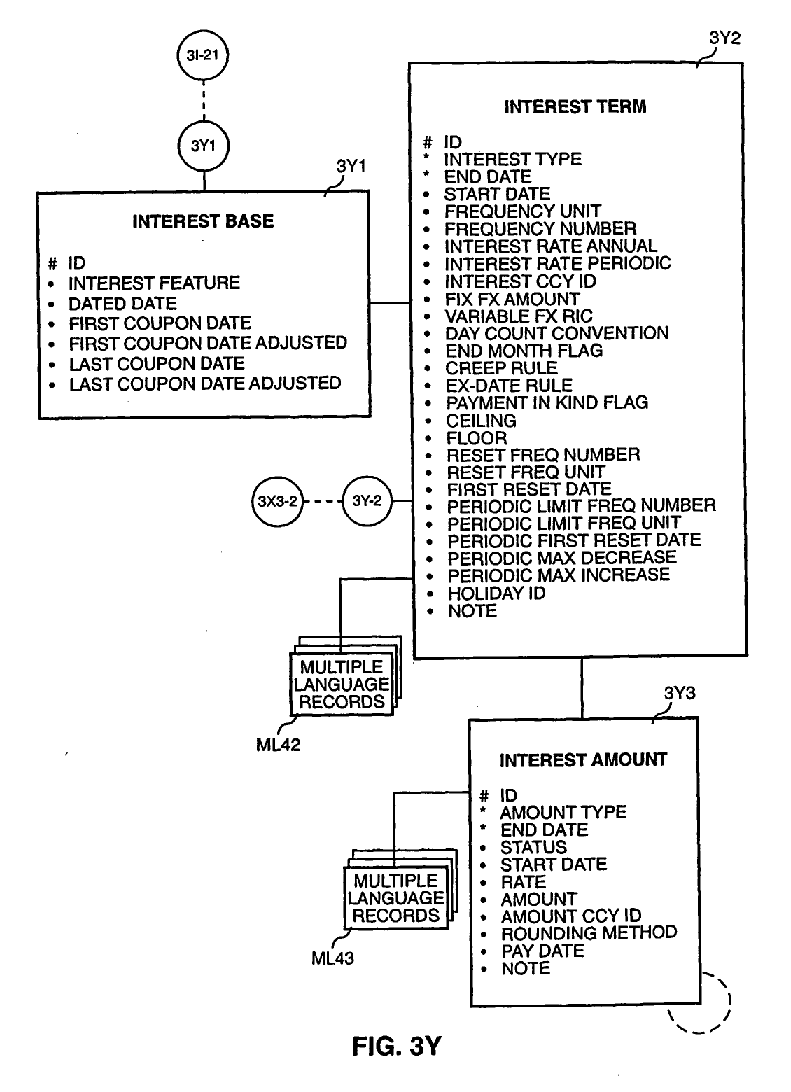

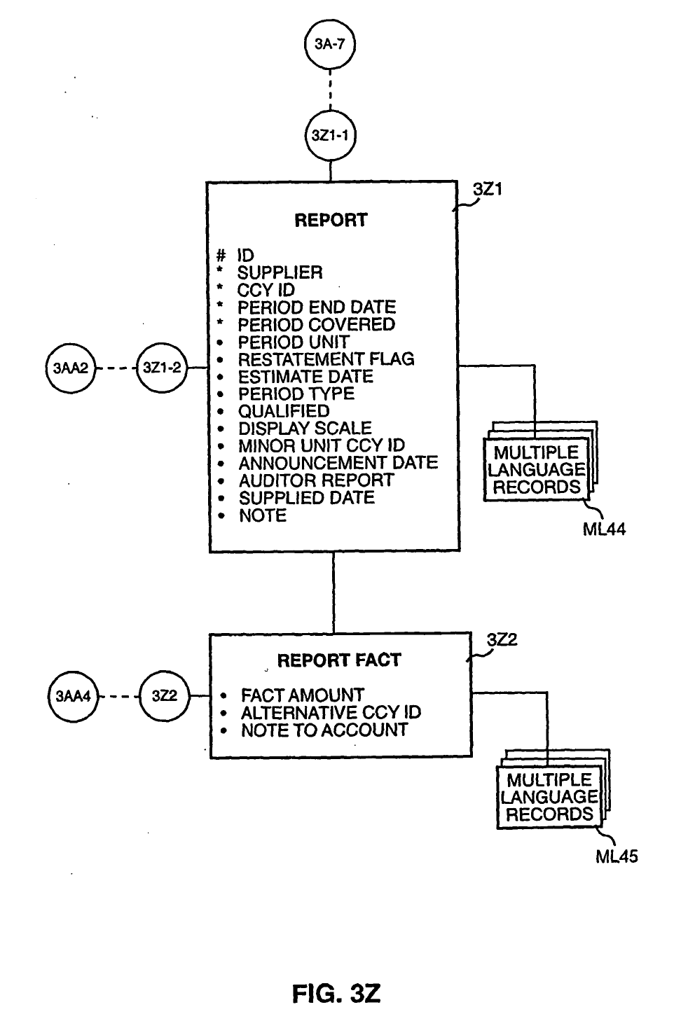

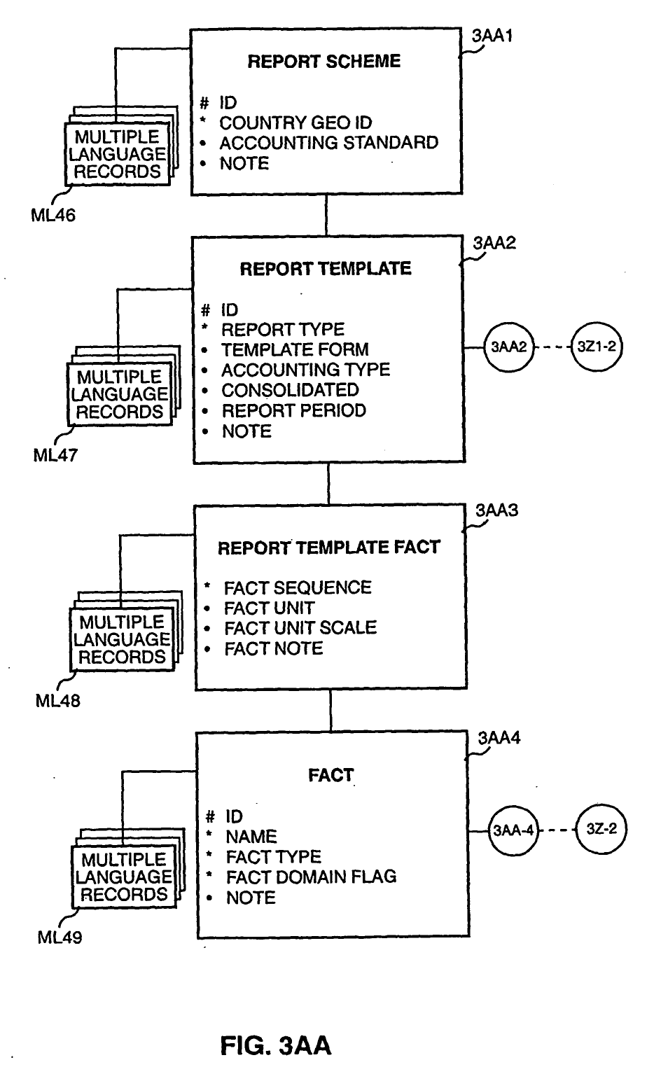

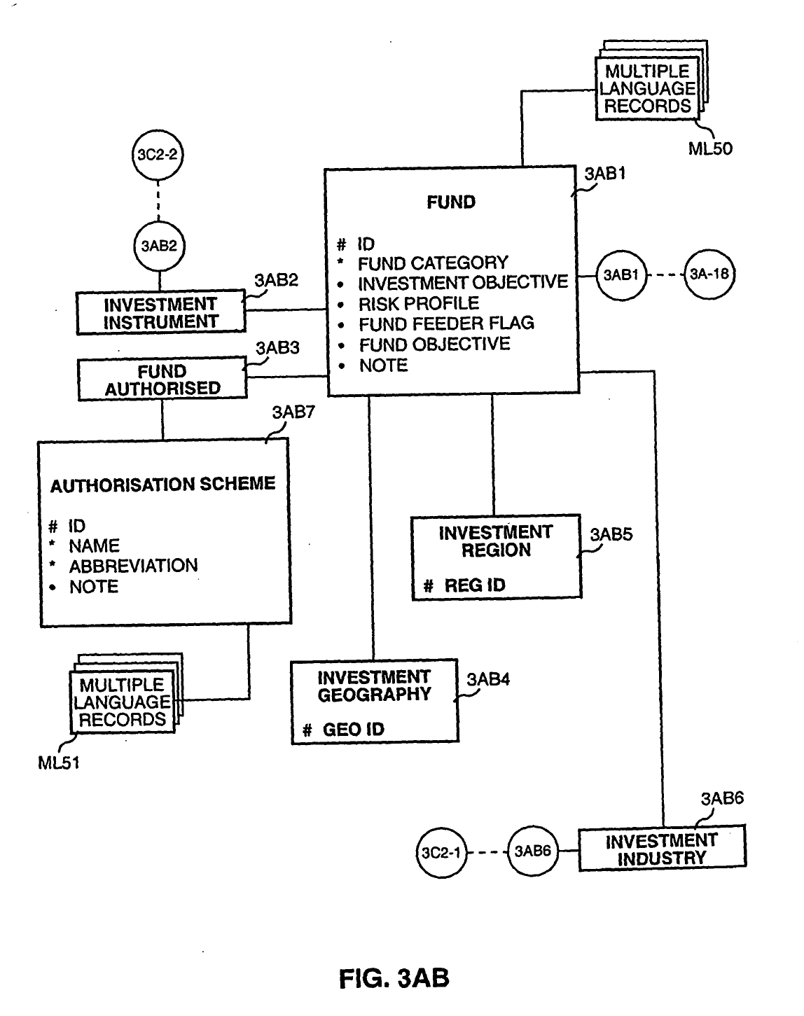

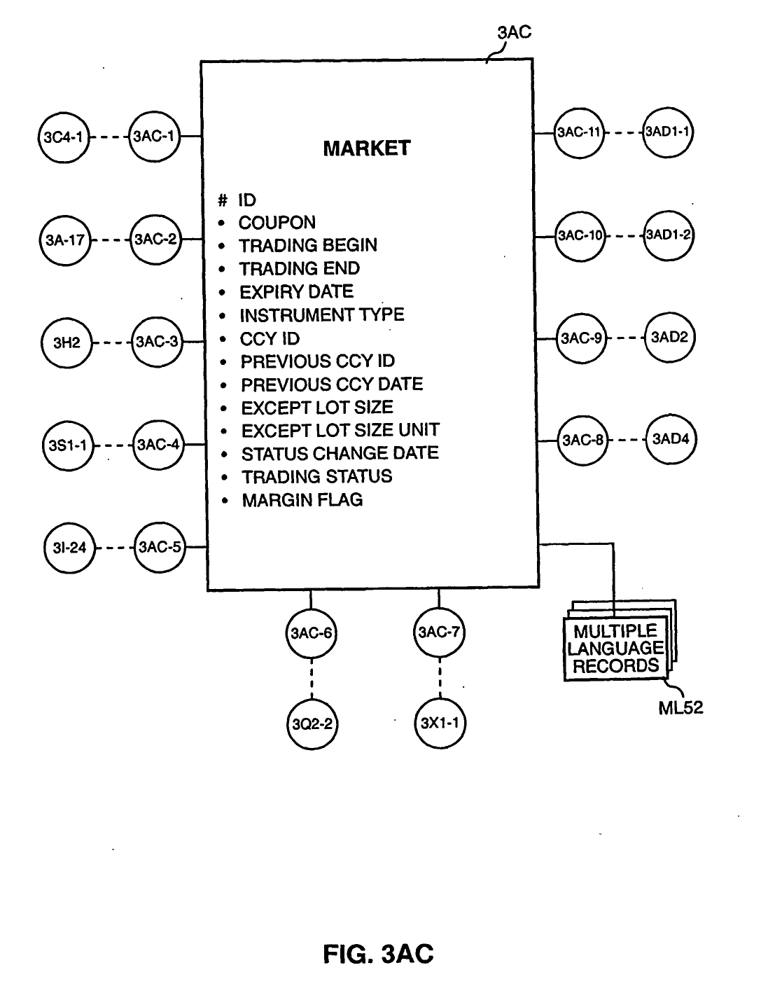

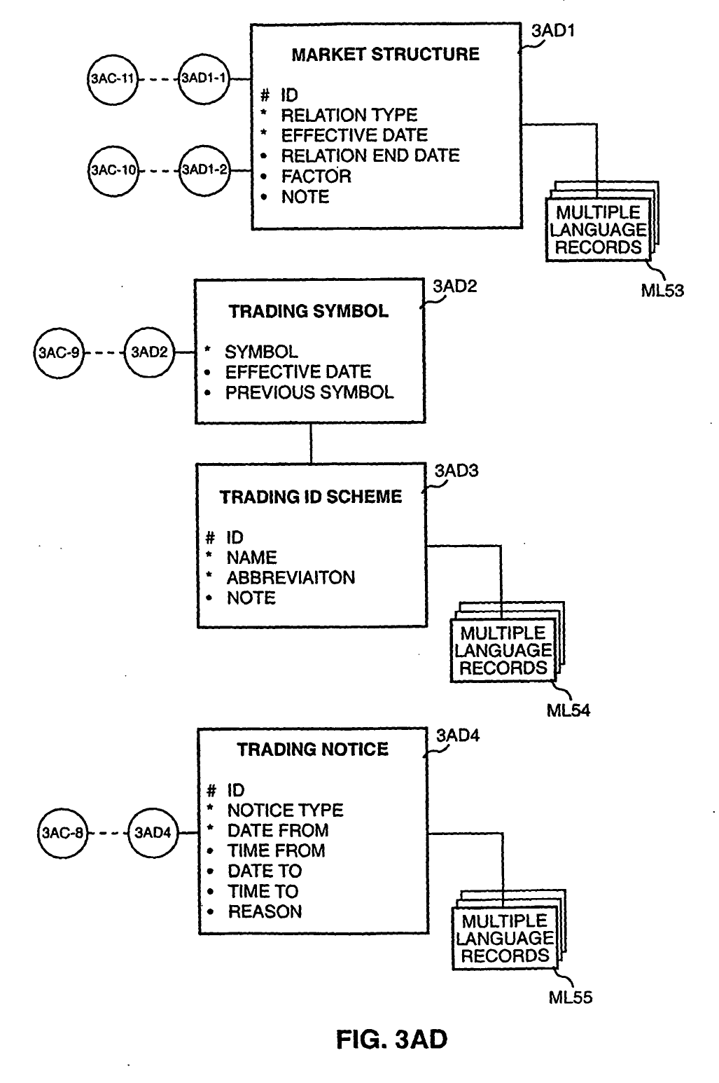

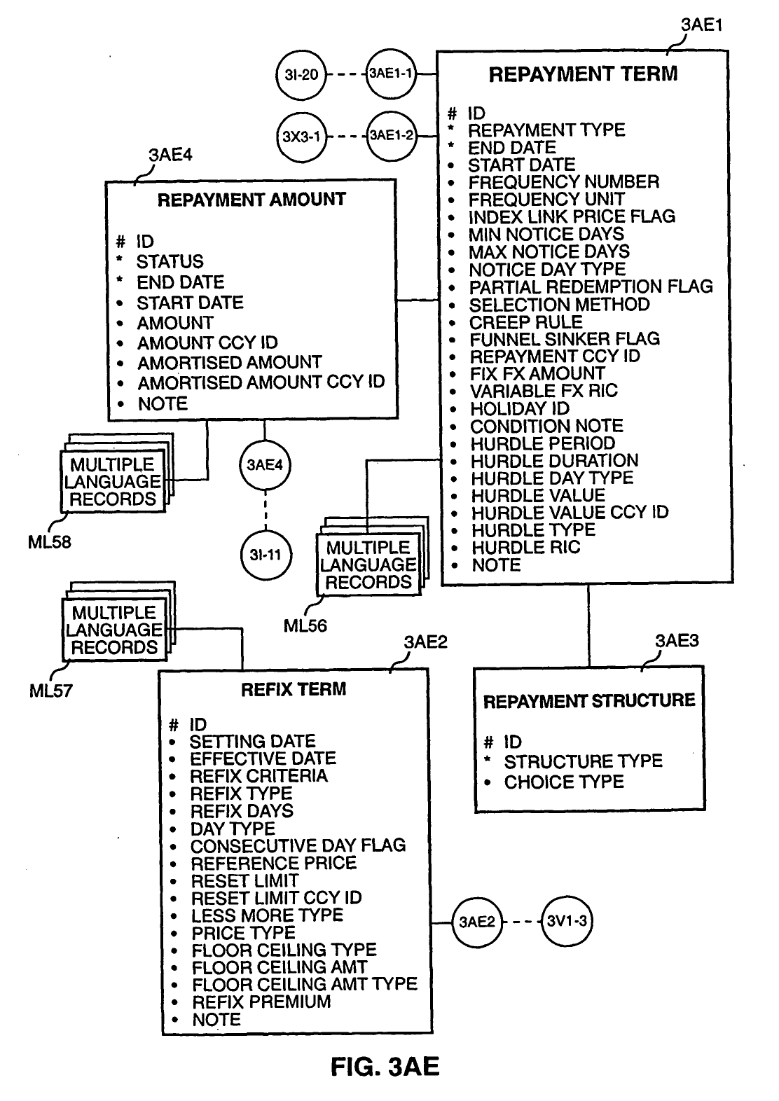

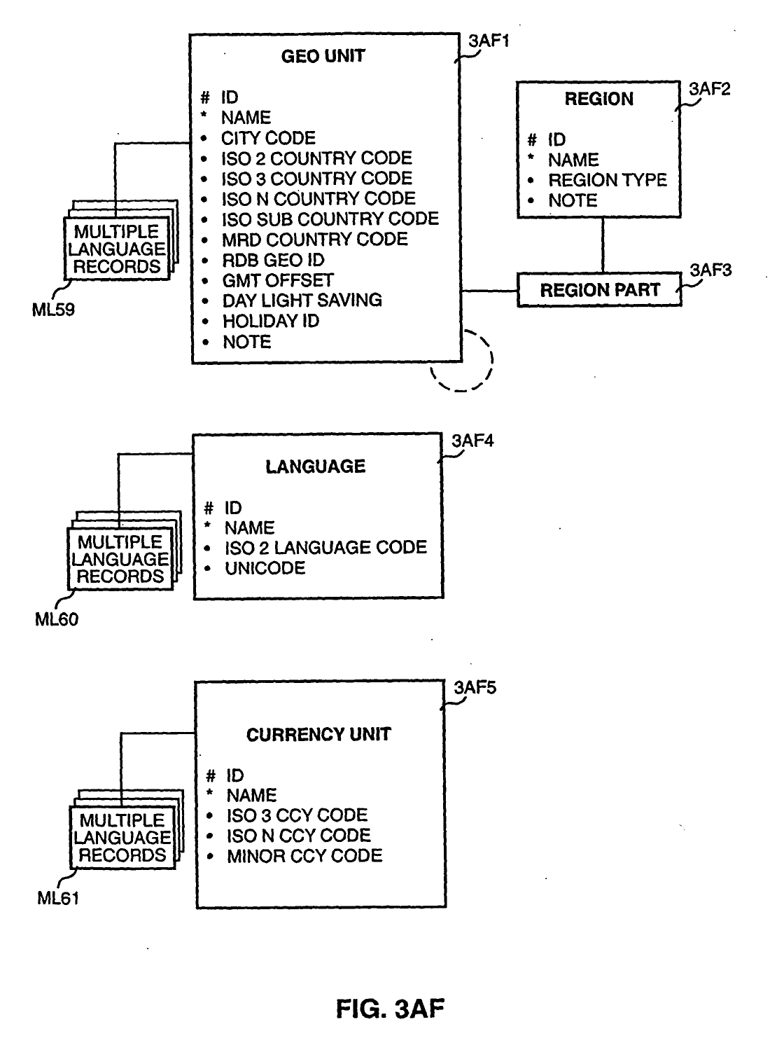

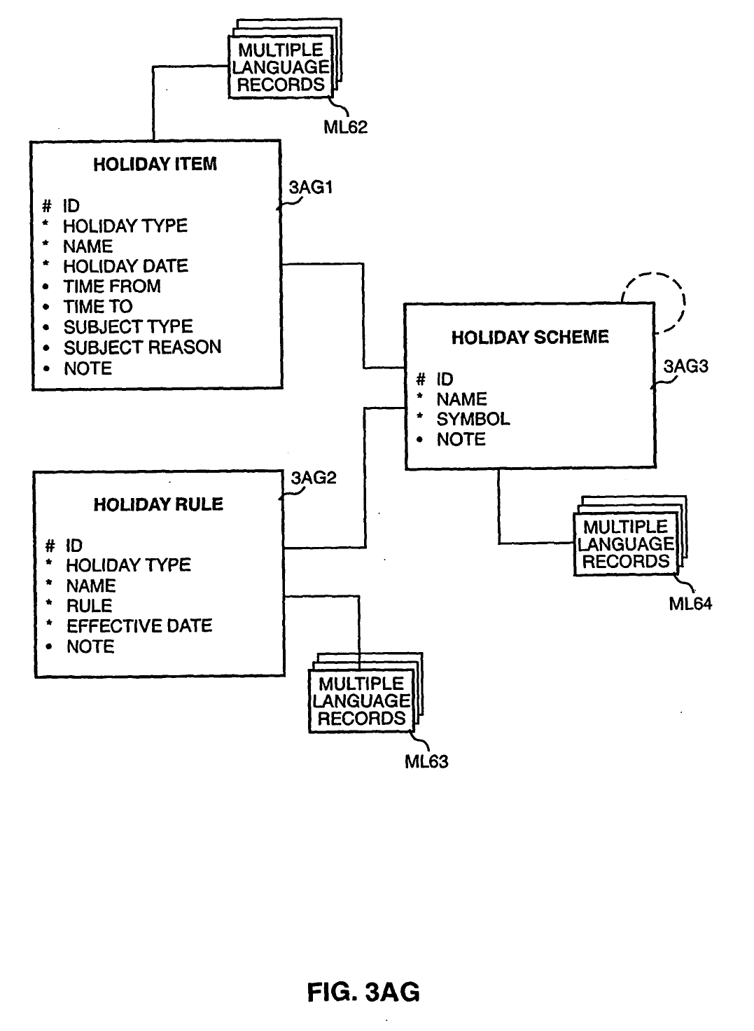

The next part of the description requires reference to FIGS.3A-3AG. As this covers several pages what follows is a brief explanation on the organization of the figures and the references that are used in these figures. Using FIG. 3A as an example, the reference FIG. 3A refers to the page with FIG. 3A, and the ORGANIZATION record on that page has a reference 3A. Now looking at the coupling points, for example, the one labeled 3A-15 - - - 3D-1, refers to record reference 3A, coupling point number 15, is coupled to record reference 3D, coupling point 1. When there is more than one record on a page, as in FIG.3B, for example, each record has a reference numeral. Hence, the four records in FIG. 3B are labeled 3B1 to 3B4. The same labeling scheme is used through out FIGS. 3A-3AG.

FIG.3A-AG shows a financial database having organization entity records, financial entity records and non-financial entity records, a variety of sub-entity records. These records are represented by an organization entity record 3A, an instrument entity record 31, a market entity record 3AC, a reports entity record 3Z, a capital events entity record 3P, and reference data entity records 3AF and 3AG. In these entity records are coupled to a variety of sub-entity records 3B-3H, 3J-3O, 3Q-3Y, 3AA-3AB, and 3AD-3AE.

A description of the entity records 3A, 3I, 3AC, 3Z, 3P, 3AF and 3AG now follows, with details on relevant sub-entity records being provided only as and when such references assist in providing a better understanding of the entity records.

With reference to FIG. 3A, an organization entity record 3A stores information of a company (a legally defmed entity), a person or individual, a fund or fund manager, a trading place (an exchange, OTC, contributor, e-community, e-market, virtual exchanges), government, supra national entities, communities, associations, factories, warehouses, or other organizations. The organization entity record 3A also stores a variety of attributes of an organization as listed therein.

With reference to FIG. 3B1, the sub-entity organization location record 3BI is related to the organization entity record 3A and stores address information for multiple locations for the organization detailed in the organization record 3A. Such information can include an indication of different types of locations, such as, headquarters, registered office, branch offices, or other types of locations of the organization.

Referring now to FIG. 3C4, the sub-entity organization relation record 3C4 is related to the organization entity record 3A. This sub-entity record 3C4 stores details of the management of the organization. The record 3C4 is flexible and supports multiple management records. In addition, titles of the members of the management of the organization, including the specific titles used by each member, can be stored. Further, the titles do not need to fit into predefined formats. Some examples of such titles are, Chairman, Managing Director, Investor Relations Officer, Finance Director, Chief Executive Officer.

In FIG. 3E1, the meeting sub-entity record 3E1 is related to the organization entity record 3A. This sub-entity record 3E1 stores information on meetings held by the organization identified in the organization entity record 3A. The record 3E1 stores the history of various types of meetings, such as Annual General Meetings (AGMs), extraordinary meetings, and others, as well as meeting agenda items.

In FIG. 3AB, the fund sub-entity record 3AB1 stores information on a variety of fund/unit trust characteristics of the fund/unit trust organization identified in the organization entity record 3A. The stored information includes an indication of the different types of investment policies (e.g. industry, geography and instrument types, etc) determined by the organization, the value of each instrument held, and the percentage of each instrument held are stored in 3C4 in FIG.3C.

A trading place is a type of organization, and there will therefore be an organization entity record for a trading place 3D3 in FIG. 3D. Sub-entity records coupled to a trading place organization entity record include type of trading place sub-entity record [3A in FIG.3A], which stores information indicating whether the trading place is, for example, an exchange, a contributor, over-the-counter (OTC), electronic communities or electronic exchanges. The exchange structures and rules are stored in FIG.3H and the listed/traded entity details in market in FIG.3AC.

Referring to FIG. 3H, another sub-entity record is an exchange structure sub-entity record 3H1 which stores information on various sections or boards of exchanges that are supported. In addition, a trading session sub-entity record 3H5 stores details of trading hours and sessions of an exchange and sub-sections of the exchange can also be supported.

With reference now to FIG. 3I, the instrument entity record stores details of financial instruments of the organization identified in organization entity record 3A. This record 31 includes all traded and non-traded security or asset types that have a value or based on which, value may be derived. The stored data includes terms and conditions from the initial public offering (IPO), conversion, repayments, amortization, sinking funds, interest payments, fees and margins, custody, settlement, and information on simple or complex derivative instruments. The major types of instruments are equity, warrants, bonds, funds, indices, economic indicators, commodities, currencies and interest rates.

With regard to equity for example, the stored information includes information on the following types of equity instruments: common stock, preferred shares, rights, young shares, foreign shares, depository receipts, participating certificates and entitlement certificates.

With regard to warrants, the stored information includes for example, information on the following types of warrants: put/call, sponsored/covered, index linked, exchange rate linked, commodity linked, basket warrants, and exotic warrants.

Bonds include fixed or straight bonds, floating rate issues (FRNs), index linked maturity issues, convertible bonds, reverse convertible issues, asset-backed securities, and other derivatives.

Funds include, for example, closed-end funds, open-end funds, fund exposure, and fund portfolio While indices supported include terms and conditions of the index, and index constituents

Economic indicators and associated information stored include terms and conditions of the indicator. Information is also stored on commodities, currencies, and interest rates, and related information including information on metals, livestock, etc., London Interbank Offering Rate (LIBOR], Hong Kong Interbank Offering Rate (HIBOR], Swap rates, foreign exchange rates, and others.

Referring now to FIG. 3Z, a report entity record 3Z stores various reports issued by the organization identified in entity record 3A. The reports include, for example, company financial reports, fund performance report, forecast statements, and exchange statements. The reports fact sub-entity record 3Z2, report scheme sub-entity record 3AA, report template sub-entity record 3AA2, report template fact record 3AA3, the fact sub-entity record 3AA4, all store information related to the report entity record 3Z, to provide information that is required to generate a variety of reports, some of which are briefly described below.

The company financial reports can include annual reports, interim or preliminary reports, and consolidated/unconsolidated reports. The Fund performance reports are issued by fund management companies and measure the performance of various funds, while the forecast statement would, for example, include earnings estimate statements from different suppliers. And finally, the exchange reports or statements are issued by exchanges i.e. when the organization identified in organization entity is an exchange.

Now referring to FIG. 3P, a capital event entity record 3P stores data on all actions happening to an instrument or an organization. These events include distribution, capital changes, purchase orders, reorganization, and legal events.

A capital event link sub-entity record 3R1, the meeting sub-entity record 3E1, instrument entity record 31, instrument sub-entity record 3Q1, and expiry date sub-entity record 3Q2 are coupled to the capital event entity record 3P.

Distribution includes case and stock dividends, and bonus issues, while capital changes include stock splits, and rights issues. Purchase orders relate to exchange/funding of instruments and buybacks of shares or other financial instruments.

Reorganization extends to mergers and acquisitions, and name changes, and legal events are bankruptcy and liquidation.

FIG. 3AC shows a market entity record 3AC which stores information on markets. The market level data consists of Reuters Identification Code (RICS), which provide details on the trading activity of instruments on different exchanges.

Various sub-entity records are coupled to the market entity record 3AC, including the market listing sub-entity record 3H2, the market structure sub-entity record 3AD1, trading symbol sub-entity record 3AD2, and trading notice sub-entity record 3AD4.

FIGS. 3AF and 3AG show various reference entity records which store information relating to geographical, currency, languages, holidays, and schemes of an organization identified in the organization entity record 3A.

A reference entity records include the geographical entity record 3AF1, and related sub-entity records 3AF3 and 3AF2, the language entity record 3AF4, the currency unit sub-entity record 3AF5, the holiday item entity record 3AG1, and related holiday scheme sub-entity record 3AG3 and holiday rule sub-entity record 3AG2.

Geographic data stored includes countries, cities, etc. that are organized according to geographic divisions. Which are related to region data that include units that are organized according to other criteria, such as political, regional, etc. Examples are the UN and ASEAN.

Currency information that is stored includes names of currencies in various standards, for example ISO standards, or other proprietary standards. Languages information include names of languages in various standards,.for example ISO standards and proprietary standards, and holidays information is stored as defined by different countries and exchanges.

The database structure in accordance with the present invention, as described, has schemes, which provide the structure with a great deal of flexibility to support local and international requirements. The following schemes are supported, industry classifications, trading conventions, rating schemes, instrument classification schemes, identifier schemes at the organization, instrument and market entity levels; and reporting schemes.

In addition, multi-language sub-entity records can be included that effectively duplicate the type of information stored in existing sub-entity records, but in the multi-language sub-entity records the information is stored in a variety of languages. With the multi-language sub-entity records, database applications can support multiple languages, thereby allowing such applications to be used and maintained internationally. It will be appreciated by those skilled in the art that the multi-language sub-entity records can be manually populated or may be populated with the use of software language translators or indeed a combination of both these methods.

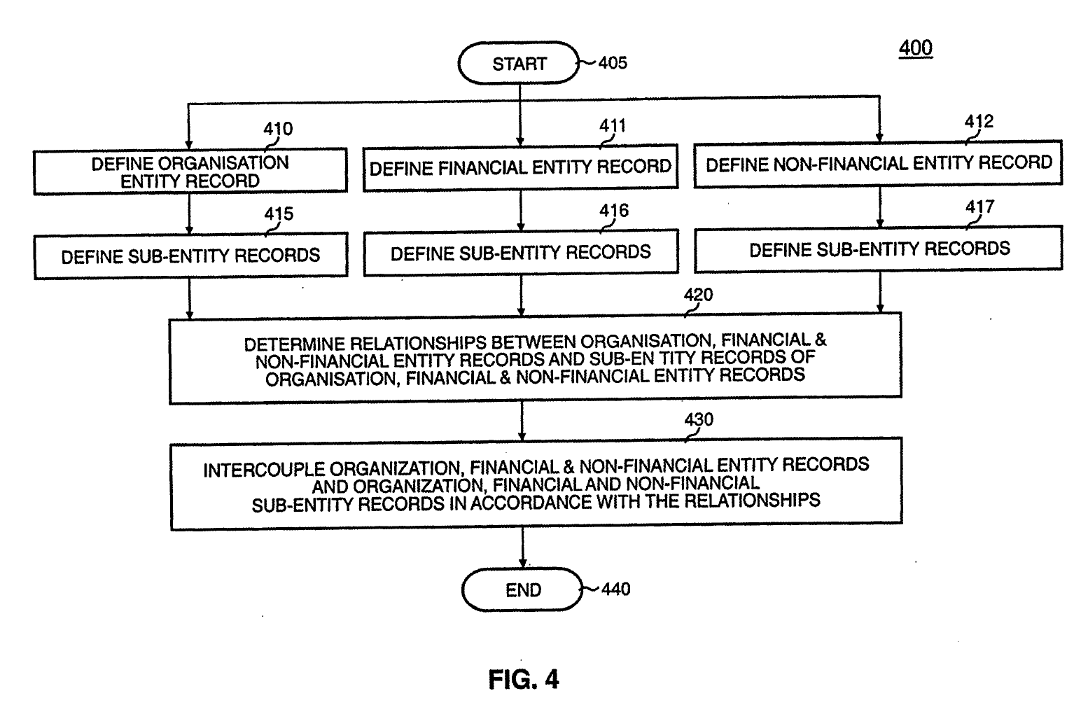

With reference to FIG. 4, a process 400 for creating the database structure 200 in FIG. 2, in accordance with the present invention, starts 405 by defining 410 organization entity records, defining 411 financial entity records, and defining 412 non-financial entity records. These steps 410, 411 and 412 can be performed independently, and even concurrently.

Next all relevant organization sub-entity records of the organization entity records are defined 415, all relevant financial sub-entity records of the financial entity records are defined 416, and all relevant non-financial sub-entity records of the non-financial entity records are defined 417. Subsequently, the relationships between the organization entity records, the financial entity records, the non-financial entity records and all the relevant organization, financial and non-financial sub-entity records, are determined 420.

Finally, the organization, financial and non-financial entity records, and the organization, financial and non-financial sub-entity records are intercoupled in accordance with the relationships determined instep 420, producing the database structure 200, and ending the process 400.

It should be noted that the organization, financial and non-financial entity records are not required to be related or linked to each other. For example, orange juice is as a non-financial entity which is a commodity, and does not belong to any organization record in the database structure, in accordance with the present invention. However, futures contracts, which is a financial entity record depends on orange juice commodities, which are non-financial entity records, and the futures contracts are traded on a commodity exchange, which is an organization entity record.

The present invention, as described, provides a database structure having inter-coupled organization entity records, financial entity record and non-financial entity records that are inter-coupled.

This is accomplished by defining the organization, the financial, non-financial entity records, and a variety of sub-entity records. Then determining the relationships between the entity record and the sub-entity records and coupling the entity and sub-entity records accordingly.

The present invention therefore provides a method and apparatus for a financial database structure which overcomes, or at least reduces the abovementioned problems of the prior art.

It will be appreciated that although only one particular embodiment of the invention has been described in detail, various modifications and improvements can be made by a person skilled in the art without departing from the scope of the present invention.

1. A database comprising:
an organization entity section for storing at least one organization entity record of at least one organization entity, and for storing a plurality of organization sub-entity records, wherein at least one of the plurality of organization sub-entity records is directly coupled to the at least one organization entity record;
a financial entity section coupled to the organization entity section, the financial entity section for storing at least one financial entity record of at least one financial entity, and for storing a plurality of financial sub-entity records, wherein at least one of the plurality of financial sub-entity records is directly coupled to the at least one financial entity record; and
a non-financial entity section coupled to the organization entity section and the financial entity section, the non-financial entity section for storing at least one non-financial entity record of at least one non-financial entity, and for storing a plurality of non-financial sub-entity records, wherein at least one of the plurality of non-financial sub-entity records is directly coupled to the at least one non-financial entity record.

2. A database in accordance with claim 1, wherein the organization entity section further comprises at least another one of the plurality of organization sub-entity records, and wherein the at least another one of the plurality of organization sub-entity records is indirectly coupled to the at least one organization entity record via at least one other intervening organization sub-entity record of the plurality of organization sub-entity records.

3. A database in accordance with claim 1, wherein the financial entity section further comprises at least another one of the plurality of financial sub-entity records, and wherein the at least another one of the plurality of financial sub-entity records is indirectly coupled to the at least one financial entity record via at least one other intervening financial sub-entity record of the plurality of financial sub-entity records.

4. A database in accordance with claim 1, wherein the non-financial entity section further comprises at least another one of the plurality of non-financial sub-entity records, and wherein the at least another one of the plurality of non-financial sub-entity records is indirectly coupled to the at least one non-financial entity record via at least one other intervening non-financial sub-entity record of the plurality of non-financial sub-entity records.

5. A database in accordance with claim 1 wherein some of the plurality of organization sub-entity records, some of the plurality of financial sub-entity records, and some of the plurality of non-financial sub-entity records are inter-coupled.

6. A database in accordance with claim 1, wherein each of the at least one organization entity record, the at least one financial entity record, and the at least one non-financial entity record comprises at least one attribute associated therewith.

7. A database in accordance with claim 1, wherein the plurality of organization sub-entity records, the plurality of financial sub-entity records and the plurality of non-financial sub-entity records, each comprise at least one attribute associated therewith.

8. A database in accordance with claim 1, wherein the at least one organization entity record is coupled to the at least one financial sub-entity record.

9. A database in accordance with claim 1, wherein the at least one financial entity record is coupled to the at least one non-financial entity record.

10. A database in accordance with claim 1, wherein the at least one non-financial entity record is coupled to at least one financial entity record.

11. A database in accordance with claim 1 further comprising a plurality of language records, wherein at least one of the plurality of language records is coupled to at least one of, the at least one organization entity record, the at least one financial entity record, the at least one non-financial entity record, the plurality of organization sub-entity records, the plurality of financial sub-entity records, and the plurality of non-financial entity records.

12. A database in accordance with claim 11 wherein the plurality of language records support a variety of languages, and wherein some of the plurality of language records store substantially similar information for display in at least some of the variety of languages.

13. A financial database comprising:
an organization entity section for storing at least one organization entity record of at least one organization entity;
a financial entity section coupled to the organization entity section, the financial entity section for storing at least one financial entity record related to the at least one financial entity; and
a non-financial entity section coupled to the organization entity section and the financial entity section, the non-financial entity section for storing at least one non-financial entity record related to at least one of, the at least one non-financial entity and the at least one organization entity.

14. A financial database in accordance with claim 13 wherein the at least one organization entity comprises a business entity.

15. A financial database in accordance with claim 13 wherein the at least one financial entity comprises a financial instrument.

16. A financial database in accordance with claim 13 wherein the at least one non-financial entity comprises a non-profit organization.

17. A financial database in accordance with claim 13, further comprising at least one of a plurality of first level sub-entity records, wherein the at least one of the plurality of first level sub-entity records is coupled to at least one of, the at least one organization entity record, the at least one financial entity record, and the at least one non-financial entity record.

18. A financial database in accordance with claim 17 wherein the at least one of the plurality of first level sub-entity records is coupled to at least two of, the at least one organization entity record, the at least one of the financial entity record, and the at least one non-financial entity records.

19. A financial database in accordance with claim 13, further comprising at least another one of the plurality of first level sub-entity records, wherein the at least another one of the plurality of first level sub-entity records is coupled to the at least one of the plurality of first level sub-entity records.

20. A financial database in accordance with claim 17 wherein the database further comprises at least one of a plurality of second level sub-entity records, wherein the at least one of the plurality of second level sub-entity records is coupled to the at least one of the plurality of first level sub-entity records.

21. A financial database in accordance with claim 20 wherein the at least one of the plurality of second level sub-entity records is coupled to at least one, the at least one organization entity record, the at least one financial entity record, and the at least one non-financial entity records.

22. A financial database in accordance with claim 20 wherein the at least one of the plurality of second level sub-entity records is coupled to at least another one of the plurality of first level sub-entity records.

23. A financial database in accordance with claim 20 wherein the at least one of the plurality of second level sub-entity records is coupled to at least another one of the plurality of second level sub-entity records.

24. A financial database in accordance with claim 20 further comprises at least one of a plurality of third level sub-entity records, wherein the at least one of the plurality of third level sub-entity records is coupled to the at least one of the plurality of second level sub-entity records.

25. A financial database in accordance with claim 24 wherein the at least one of the plurality of third level sub-entity records is coupled to the at least one of, the at least one organization entity record, the at least one financial entity record, and the at least one non-financial entity record.

26. A financial database in accordance with claim 24 wherein the at least one of the plurality of third level sub-entity records is coupled to the at least one of the plurality of first level sub-entity records.

27. A financial database in accordance with claim 24 wherein the at least one of the plurality of third level sub-entity records is coupled to the at least one of the plurality of second level sub-entity records.

28. A financial database in accordance with claim 24 further comprising at least another one of the plurality of third level sub-entity records, wherein the at least another one of the plurality of third level sub-entity records is coupled to the at least one of the plurality of third level sub-entity records.

29. A financial database in accordance with claim 24 further comprising at least one of a plurality of fourth level sub-entity records, wherein the at least one of the plurality of fourth level sub-entity records is coupled to the at least one of the plurality of third level sub-entity records.

30. A method comprising the steps of:
a) defining at least one organization entity record for at least one organizational entity;
b) defining at least one financial entity record for at least one financial entity;
c) defining at least one non-financial entity record for at least one non-financial entity;
d) defining a plurality of sub-entity records for each of the at least one organization entity record, the at least one financial entity record, and the at least one non-financial entity record;
e) determining a plurality of relationships between at least some of the plurality of sub-entity records and the at least one organization entity record, the at least one financial entity record, and the at least one non-financial entity record; and
f) inter-coupling the at least some of the plurality of sub-entity records, the at least one organization entity, the at least one financial entity and the at least one non-financial entity in accordance with the plurality of relationships determined instep (e).
